(19) United States
(12) Patent Application Publication
(10) Pub. No.: US 2026/0178906 A1
(43) Pub. Date: Jun. 25, 2026

(54) REAL-TIME STATE PERCEPTION AND EARLY WARNING SYSTEM AND METHOD BASED ON FIELD-ELECTRICAL INTEGRATION FOR GAS INSULATED SWITCHGEAR (GIS)

(71) Applicants: HEFEI UNIVERSITY OF TECHNOLOGY, Hefei (CN); STATE GRID ANHUI ULTRA HIGH VOLTAGE COMP, Hefei (CN)

(72) Inventors: Qiyue LI, Hefei (CN); Haibin ZHANG, Hefei (CN); Xueyou ZHANG, Hefei (CN); Zhenyu GUO, Hefei (CN); Huan MA, Hefei (CN); Wei SUN, Hefei (CN); Weitao LI, Hefei (CN); Xin LIU, Hefei (CN); Yan ZENG, Hefei (CN)

(73) Assignees: HEFEI UNIVERSITY OF TECHNOLOGY, Hefei (CN); STATE GRID ANHUI ULTRA HIGH VOLTAGE COMP, Hefei (CN)

(21) Appl. No.: 19/539,164

(22) Filed: Feb. 13, 2026

Related U.S. Application Data
(63) Continuation of application No. PCT/CN2025/095947, filed on May 20, 2025.

(30) Foreign Application Priority Data
Nov. 14, 2024 (CN) 202411626739.3

(51) Int. Cl. G06N 3/08; G06N 3/045

(52) U.S. Cl. CPC G06N 3/08; G06N 3/045

(57) ABSTRACT

The provided is a real-time state perception and early warning system and method based on field-electrical integration for a gas insulated switchgear (GIS). The system includes an embedded device for synchronous signal acquisition and measurement and an industrial personal computer (IPC), where a simulator, a location searcher, and an early warning device are deployed in the IPC. The embedded device obtains a full time-domain waveform diagram including a time-domain waveform diagram and a frequency-domain waveform diagram of a partial discharge signal when detecting, based on pre-screened strongly correlated features, that an electromagnetic field signal inside the GIS contains the partial discharge signal. The simulator performs coarse positioning on a partial discharge source based on the full time-domain waveform diagram of partial discharge in the GIS, performs simulation enhancement calculation by using a coarse positioning result as an initial injection point, and obtains simulation enhancement data of the partial discharge source.

### CROSS-REFERENCE TO THE RELATED APPLICATIONS

This application is a continuation application of International Application No. PCT/CN2025/095947, filed on May 20, 2025, which is based upon and claims priority to Chinese Patent Application No. 202411626739.3, filed on Nov. 14, 2024, the entire contents of which are incorporated herein by reference.

### TECHNICAL FIELD

The present disclosure relates to the technical field of electric power equipment, and in particular to a real-time state perception and early warning system and method based on field-electrical integration for a gas insulated switchgear (GIS).

### BACKGROUND

A high-voltage gas insulated switchgear (GIS) has high performance and reliability, which are crucial for ensuring stable operation of a power system, improving the transmission efficiency of a power grid, and guaranteeing the safety of the power supply.

With the widespread application of GIS, frequent equipment failures caused by insulation aging, component loosening, and other problems in GIS have seriously threatened safe operation of substations at all levels. Partial discharge is an important characterization of a defect state in GIS. Technical research on positioning and measurement of partial discharge is a key approach for effectively perceiving a state of GIS and conducting analysis and early warning. Generally, state perception and long-term analysis and early warning are achieved by acquiring an ultra-high frequency (UHF) electromagnetic wave signal inside GIS, monitoring partial discharge, and determining a location of a partial discharge source when detecting a partial discharge signal, thereby ensuring safe and stable operation of GIS.

In a process of performing discharge detection using a UHF signal, a plurality of reflections of the UHF signal along different propagation paths within a complex topology of GIS affect positioning accuracy. The multipath effect results in different time delays of signals arriving at a UHF sensor, thus causing a positioning error and making it impossible for a positioning system to accurately identify a location of a discharge source. Meanwhile, high-precision positioning models adopted in related technologies (such as fuzzy neural networks and deep learning models) have complex structures, and are difficult to apply in real time because their training and optimization processes require substantial calculation resources.

To address the above problems, this disclosure provides a method that integrates measured UHF signal values with a simulation model to calculate and perform fast iterative searches for an optimal matching location is provided. However, the technical challenges involved are as follows:

(1) Most existing partial discharge signal acquisition devices transmit a compressed partial discharge signal to an upper computer in the form of a phase resolved partial discharge (PRPD) pattern, and therefore cannot restore the detected high-frequency and complete time-domain partial discharge signal of a full time-domain waveform to the upper computer, thereby failing to meet a requirement for accurate positioning of the partial discharge signal inside GIS. Currently, the UHF signal needs to be acquired by using a data acquisition device with a high sampling rate. Because a sampling rate is proportional to positioning accuracy, improving the sampling accuracy inevitably results in problems such as insufficient calculation resources on a chip. The high sampling rate results in a large volume of data, thereby increasing the processing and transmission burden, and transmission delays and data synchronization issues affect real-time performance. Therefore, there are no high-speed and high-performance real-time acquisition/matching/detection methods for the partial discharge signal in the related technologies.

(2) When traditional numerical methods are used for electromagnetic field simulation with non-uniform grids, they must address complex coupling between fine and coarse grids and face difficulties in establishing boundary conditions. Meanwhile, simulation based on non-uniform grid division has high calculation resource requirements. Simulations with large number of grids and grid densities lead to long calculation times and low simulation speeds, which seriously affect detection time when dealing with high-frequency partial discharge detection problems in GIS. Although coarse-grid simulation can reduce time cost, simulation accuracy is low, which affects quality of partial discharge detection. Therefore, there is no fast and high-precision electromagnetic field distribution simulation technology applicable to a multi-structure GIS in the related technologies, and electromagnetic field distribution simulation cannot provide a theoretical basis for high-performance real-time perception of GIS.

(3) A real-time measured UHF signal usually needs preprocessing and cleaning to reduce the impact of noise and to extract a valid signal as much as possible. However, the quality and clarity of input data required for fast electromagnetic field simulation are generally higher than those achievable with actual measured data. This makes it difficult to match simulation results with the actual measured data, thereby preventing the organic integration of the fast electromagnetic field simulation with noisy measured data.

### SUMMARY

A technical problem to be solved in the present disclosure is how to achieve high-performance real-time state perception and early warning based on field-electrical integration of a GIS.

The present disclosure solves the above technical problem by the following technical solutions:
The present disclosure provides a real-time state perception and early warning system based on field-electrical integration for a GIS, including an embedded device for synchronous signal acquisition and measurement and an industrial personal computer (IPC), where a simulator, a location searcher, and an early warning device are deployed in the IPC;
the embedded device for synchronous signal acquisition and measurement is configured to obtain a full time-domain waveform diagram including a time-domain waveform diagram and a frequency-domain waveform diagram of a partial discharge signal when detecting, based on pre-screened strongly correlated features, that an electromagnetic field signal inside the GIS contains the partial discharge signal;
the simulator is configured to perform coarse positioning on a partial discharge source based on the full time-domain waveform diagram of partial discharge in the GIS, perform simulation enhancement calculation by using a coarse positioning result as an initial injection point, and obtain simulation enhancement data of the partial discharge source;
the location searcher is configured to perform iterative search on a measured discharge intensity calculated based on the full time-domain waveform diagram and a simulation enhancement result, and obtain an actual discharge location of the partial discharge source; and
the early warning device is configured to issue an early warning based on the full time-domain waveform diagram and early warning information containing the actual discharge location of the partial discharge source.

Further, the embedded device for synchronous signal acquisition and measurement includes:
a signal acquisition location determining module configured to determine an installation location of each sensor in a signal acquisition module;
the signal acquisition module configured to acquire the electromagnetic field signal inside the GIS;
a signal processing front end configured to perform signal conditioning on the electromagnetic field signal transmitted by the signal acquisition module, and transmit a conditioned signal to an analog-to-digital converter (ADC);
the ADC configured to convert the conditioned signal from an analog signal to a digital signal and transmit the digital signal to a signal measurement module; and
the signal measurement module configured to monitor the digital signal based on the pre-screened strongly correlated features, and obtain the full time-domain waveform diagram including the time-domain waveform diagram and the frequency-domain waveform diagram of the partial discharge signal when determining that the partial discharge signal is monitored, where the strongly correlated features include time-domain strongly correlated features and frequency-domain strongly correlated features.

Further, the embedded device for synchronous signal acquisition and measurement further includes: a feature screening module configured to take time-domain and frequency-domain features for detecting the partial discharge signal as nodes of a graph neural network (GNN) to perform correlation strength screening, and obtain the time-domain strongly correlated features and the frequency-domain strongly correlated features, where a connection line between the nodes represents a relationship between features represented by the nodes.

Further, the feature screening module includes:
a feature map construction unit configured to set xᵥ, x_{co[v]}, h_{ne[v]}, x_{ne[v]} to respectively represent a feature vector of a node v, a feature vector of an edge, a state vector of the node v and a neighboring node of the node v, and a feature vector of the neighboring node of the node v in a complete feature map G=(V,E) of the GNN, where V represents a node set, and E represents an edge set;
an aggregation updating unit configured to perform aggregation updating on input node and edge information based on a local transition function for updating a node state, and output a node label, which is expressed by a following formula:

$${h}_{v} = f ( {x}_{v} , {x}_{c o [ v ]} , {h}_{n e [ v ]} , {x}_{n e [ v ]} )$$

$${o}_{v} = g ( {h}_{v} , {x}_{v} )$$

where f(·) represents the local transition function for updating the node state, g(.) represents a local output function, hᵥ represents a state vector learned through iterative learning of the GNN, and oᵥ represents the node label; and
an iteration unit configured to calculate a correlation between a node and an adjacent node during continuous iteration of the GNN, and obtain the time-domain strongly correlated features and the frequency-domain strongly correlated features.

Further, the iteration unit is specifically configured to:
respectively set H, O, X, and X_{N} to a vector constructed by superimposing state vectors of all the nodes, a vector constructed by superimposing all output labels, a vector constructed by superimposing feature vectors of all the nodes and all edges, and a vector constructed by superimposing feature vectors of all the nodes, and write formulas in a more compact form as follows:

$$O = G ( H , {X}_{N} )$$

$${H}^{t + 1} = F ( {H}^{t} , X )$$

where H^{t} represents a t^{th} iteration of the H, H^{t+1}=F(H^{t}, X) represents an operation of obtaining state vectors of all the nodes in a t+1^{th} iteration based on a feature vector and a state vector of the t^{th} iteration through a global transition function, and F(.) and G(.) respectively represent the global transition function and a global output function, which are respectively obtained by stacking local transition functions f(·) and local output functions g(.) of all the nodes; and
in an iteration process, determine nodes with similar states, nodes with complementary states, and overall impacts of all the nodes on the GNN, and take one node selected from the nodes with similar states, one node merged from the nodes with complementary states, and a node with a greatest overall impact on the GNN as the strongly correlated features.

Further, the signal measurement module includes:
a caching unit configured to cache the digital signal;
a first monitoring unit configured to extract the time-domain strongly correlated features from the digital signal, determine, based on the time-domain strongly correlated features, that the partial discharge signal is monitored, and output a first time-domain waveform diagram during discharge;
a second monitoring unit configured to extract the frequency-domain strongly correlated features from the digital signal, determine, based on the frequency-domain strongly correlated features, that the partial discharge signal is monitored, and output a frequency-domain waveform diagram during the discharge; and
a waveform synthesis unit configured to obtain the full time-domain waveform diagram of the partial discharge signal based on the first time-domain waveform diagram and the frequency-domain waveform diagram.

Further, the second monitoring unit includes:
a Fourier transform subunit configured to perform at least two fast Fourier transform operations on the electromagnetic field signal, and obtain frequency-domain data of at least two frequency bands; and
a normalization subunit configured to extract the frequency-domain strongly correlated features from frequency-domain data of each of the at least two frequency bands, perform normalization processing on a frequency-domain waveform corresponding to each of the at least two frequency bands when determining that the frequency-domain data of each of the at least two frequency bands exceeds a second discharge threshold after analyzing and matching the frequency-domain strongly correlated features, and obtain the frequency-domain waveform diagram during the discharge.

Further, the waveform synthesis unit includes:
a waveform conversion subunit configured to convert the frequency-domain waveform diagram into a second time-domain waveform diagram during the discharge; and
a waveform synthesis subunit configured to synthesize the first time-domain waveform diagram and the second time-domain waveform diagram, and obtain the full time-domain waveform diagram of the partial discharge signal.

Further, the simulator includes:
a simulation module configured to take the coarse positioning result that is of the partial discharge source and obtained based on the full time-domain waveform diagram as an initial injection point of a three-dimensional simulation model of the GIS to simulate a partial discharge phenomenon of the GIS, and perform simulation calculation to obtain a coarse-grid simulation result; and
an enhancement module configured to enhance the coarse-grid simulation result by using an enhancement model, and obtain the simulation enhancement data.

Further, the simulation module includes:
a spatial discretization unit configured to discretize the three-dimensional simulation model of the GIS into spatial grids, and determine a corresponding relationship between a number and spatial coordinate data of each grid node; and
a differential simulation unit configured to inject the coarse positioning result into a corresponding spatial grid as the initial injection point to simulate the partial discharge phenomenon of the GIS, convert a Maxwell's equation describing an electromagnetic field of the GIS into a fourth-order matrix, solve the fourth-order matrix by using a four-step hybrid implicit-explicit finite-difference time domain (HIE-FDTD) algorithm, and calculate field strength data of each grid node.

Further, the differential simulation unit includes:
a matrix reconstruction subunit configured to convert the Maxwell's equation describing the electromagnetic field of the GIS into a form of a sixth-order matrix:

$$\frac{\partial \vec{u}}{\partial t} = [ M ] \vec{u}$$

where \vec{u} represents a vector composed of components of an electric field and a magnetic field in a rectangular coordinate system, and [M] represents the sixth-order matrix;
a matrix conversion subunit configured to convert the form of the sixth-order matrix into the form of the fourth-order matrix:

$$\frac{\partial \vec{u}}{\partial t} = \frac{[ {A}_{H} ]}{2} \vec{u} + \frac{[ {B}_{H} ]}{2} \vec{u} + \frac{[ {A}_{H} ]}{2} \vec{u} + \frac{[ {B}_{H} ]}{2}$$

$$where [ {A}_{H} ] is [ \begin{matrix}0 & 0 & 0 & 0 & 0 & \frac{1}{ε} \frac{\partial }{\partial y} \\ 0 & 0 & 0 & \frac{1}{ε} \frac{\partial }{\partial z} & 0 & 0 \\ 0 & 0 & 0 & 0 & \frac{1}{ε} \frac{\partial }{\partial x} & 0 \\ 0 & \frac{1}{μ} \frac{\partial }{\partial z} & 0 & 0 & 0 & 0 \\ 0 & 0 & \frac{1}{μ} \frac{\partial }{\partial x} & 0 & 0 & 0 \\ \frac{1}{μ} \frac{\partial }{\partial y} & 0 & 0 & 0 & 0 & 0\end{matrix} ] , and$$

$$[ {B}_{H} ] is [ \begin{matrix}0 & 0 & 0 & & 0 & - \frac{1}{ε} \frac{\partial }{\partial z} & & 0 \\ 0 & 0 & 0 & & 0 & 0 & - & \frac{1}{ε} \frac{\partial }{\partial x} \\ 0 & 0 & 0 & - & \frac{1}{ε} \frac{\partial }{\partial y} & 0 & & 0 \\ 0 & 0 & - \frac{1}{μ} \frac{\partial }{\partial y} & & 0 & 0 & & 0 \\ - \frac{1}{μ} \frac{\partial }{\partial z} & 0 & 0 & & 0 & 0 & & 0 \\ 0 & - \frac{1}{μ} \frac{\partial }{\partial x} & 0 & & 0 & 0 & & 0\end{matrix} ] ; and$$

a solving subunit configured to solve the form of the fourth-order matrix by using the four-step HIE-FDTD algorithm, and calculate the field strength data of each grid node.

Further, the solving subunit is configured to perform following steps:
decomposing the four-step HIE-FDTD algorithm into four sub-steps in a time domain, namely n→n+¼, n+¼→n+2/4, n+2/4→n+¾, and n+¾→n+1, and for each of the sub-steps, using a semi-implicit difference scheme to calculate a tridiagonal implicit form of the field strength data of the grid node; and
solving the tridiagonal implicit form by using a chasing method, and obtaining the field strength data of the grid node.

Further, the enhancement model adopts a differential deep learning network model, and the coarse-grid simulation result includes coarse-grid structure data and coarse-grid field strength data, where the differential deep learning network model includes an enhancement network and a structural similarity network that are connected in sequence, and the enhancement network includes a self-adjustment module and a differential convolution module;
the coarse-grid structure data and the coarse-grid field strength data are respectively calculated by using the self-adjustment module and the differential convolution module, and a fine-grid enhanced grid structure feature and a fine-grid enhanced field strength feature are obtained;
the fine-grid enhanced grid structure feature and the fine-grid enhanced field strength feature are matched by using the structural similarity network, and a similarity feature is calculated; and
the simulation enhancement data is calculated based on the similarity feature.

Further, the self-adjustment module includes a first convolutional layer and a second convolutional layer that are connected in sequence, and an output feature of the first convolutional layer and an output feature of the second convolutional layer are output to an activation function layer after a first addition operation; and
the coarse-grid structure data is used as an input of the first convolutional layer, supplementary grid size information of the coarse-grid structure data is used as an input of the second convolutional layer, a bias vector of the coarse-grid structure data is used as an input of the first addition operation, and the coarse-grid structure data and the supplementary grid size information of the coarse-grid structure data are output to the first addition operation through a residual connection.

Further, the differential convolution module includes a differential convolutional layer, a size integration layer, a self-attention mechanism layer, and a third convolutional layer that are connected in sequence, and an activation function is connected after the third convolutional layer;
the coarse-grid field strength data is used as an input of the differential convolutional layer, and the differential convolutional layer is configured to calculate field strength features of different sizes of the coarse-grid field strength data by using a differential algorithm; and
the size integration layer is configured to sum the field strength features of different sizes calculated by the differential convolutional layer, and obtain a reorganized field strength feature.

Further, a convolution kernel of the differential convolutional layer adopts any one of a five-point differential convolution kernel, a weighted differential convolution kernel, a multi-scale differential convolution kernel, a directional differential convolution kernel, a nine-point differential convolution kernel, and a hybrid differential convolution kernel.

Further, the structural similarity network includes a first branch network, a second branch network, a second addition operation, and a first multi-layer perceptron (MLP), outputs of the first branch network and the second branch network are both connected to the second addition operation, an output of the second addition operation is connected to the first MLP, and an activation function is connected after the first MLP.

Further, the first branch network includes a convolutional neural network (CNN) layer and a batch normalization operation that are connected in sequence, and an activation function is connected after the batch normalization operation; and

the second branch network includes a second MLP, and an activation function is connected after the second MLP.

Further, that the fine-grid enhanced grid structure feature and the fine-grid enhanced field strength feature are matched by using the structural similarity network, and a similarity feature is calculated includes:
extracting structural feature information of the fine-grid enhanced grid structure feature by using the first branch network, which is expressed by a following formula:

$${f}_{k , S}^{CNN} = ReLU ( BatchNorm ( C N N ( {f}_{k , S}^{new} ) ) )$$

where

$${f}_{k , S}^{CNN}$$

represents feature information of a k^{th} fine-grid enhanced grid structure feature,

$${f}_{k , S}^{new}$$

represents the fine-grid enhanced grid structure feature, CNN( ) represents a stacked convolution operation, BatchNorm( ) represents the batch normalization operation, and ReLU represents the activation function;
extracting field strength feature information of the fine-grid enhanced field strength feature by using the second branch network, which is expressed by a following formula:

$${f}_{k , E}^{MLP} = ReLU ( M L P ( {f}_{k , E}^{new} ) )$$

where

$${f}_{k , E}^{MLP}$$

represents feature information of a k^{th} fine-grid enhanced field strength feature,

$${f}_{k , E}^{new}$$

represents the fine-grid enhanced field strength feature, and MLP( ) represents an operation performed by the second MLP;
calculating a combined field strength and structure feature based on modulation weights corresponding to the feature information of the fine-grid enhanced grid structure feature and the feature information of the fine-grid enhanced field strength feature, which is expressed by a following formula:

$${f}_{k , combined} = α \cdot {f}_{k , S}^{CNN} + β \cdot {f}_{k , E}^{MLP}$$

where f_{k,combined} represents the combined field strength and structure feature, and α and β respectively represent the modulation weights corresponding to the feature information of the fine-grid enhanced grid structure feature and the feature information of the fine-grid enhanced field strength feature; and
calculating the similarity feature based on the combined field strength and structure feature, which is expressed by a following formula:

$${f}_{k , final} = ReLU ( M L {P}_{final} ( {f}_{k , combined} ) )$$

where f_{k,final} represents the similarity feature, and MLP_{final}( ) represents an operation performed by the first MLP.

Further, that the simulation enhancement data is calculated based on the similarity feature includes:
calculating regularized coarse-grid structure data, regularized coarse-grid field strength data, a regularized fine-grid enhanced grid structure feature, and a regularized fine-grid enhanced field strength feature respectively based on the coarse-grid structure data, the coarse-grid field strength data, the fine-grid enhanced grid structure feature, and the fine-grid enhanced field strength feature;
calculating grid structure consistency based on the regularized coarse-grid structure data and the regularized fine-grid enhanced grid structure feature;
calculating grid field strength consistency based on the regularized coarse-grid field strength data and the regularized fine-grid enhanced field strength feature;
calculating a compensation for a grid field strength loss based on the grid structure consistency and the grid field strength consistency;
calculating fine-grid enhanced structure data based on the fine-grid enhanced grid structure feature, the compensation for the grid field strength loss, and the similarity feature; and
calculating the simulation enhancement data based on the fine-grid enhanced field strength feature, the compensation for the grid field strength loss, and the similarity feature.

Further, the simulation enhancement data includes an enhanced discharge location and an enhanced discharge intensity, and the location searcher includes:
a state transition model construction module configured to reconstruct an ant colony algorithm by using a Markov decision model based on an enhanced discharge location and an enhanced discharge intensity at each time point to construct a state transition model corresponding to a process of exploring the actual discharge location of the partial discharge source by taking the coarse positioning result of the partial discharge source as a center;
a heuristic space parameterization module configured to generate a heuristic metric by using a GNN-based heuristic learner, and convert the state transition model into a location exploration model that is affected by the heuristic metric and requires graph traversal; and
an iterative search module configured to perform iterative search on the location exploration model by using a neural-guided perturbation-interleaved local search algorithm, and obtain the actual discharge location of the partial discharge source.

Further, the state transition model construction module is configured to:
construct, based on a simulated discharge location and a simulated discharge intensity at each time point, a corresponding state space [symbol] in the process of exploring the actual discharge location of the partial discharge source in the simulator:

$$𝕊 = [ {𝕤}_{1} , … , {𝕤}_{t} , … , {𝕤}_{T} ]$$

$${𝕤}_{t} = [ {p}_{t} , {E}_{t} ]$$

where [symbol] ₜ represents a corresponding state when a partial discharge source node i is explored at a t^{th} time point in the simulator, pₜ represents a simulated discharge location at the t^{th} time point, Eₜ represents a simulated discharge intensity at the t^{th} time point, [symbol] ₁=[P, E] represents an operation of taking an initial discharge intensity E and an initial discharge location P that are of the partial discharge source and obtained based on the full time-domain waveform diagram of the partial discharge in the GIS as an initial state, T represents an exploration cycle, and t=1, 2, . . . , T;
construct a corresponding action space [symbol] in the process of exploring the actual discharge location of the partial discharge source in the simulator:

$$𝔸 = [ {𝕒}_{1} , … , {𝕒}_{t} , … , {𝕒}_{T} ]$$

where [symbol] ₜ represents an action at the t^{th} time point, and the action [symbol] ₜ is selected based on a ε—greedy strategy; and
reconstruct the ant colony algorithm to construct the state transition model corresponding to the process of exploring the actual discharge location of the partial discharge source by taking the initial discharge location of the partial discharge source as the center:

$$ℙ ( {𝕤}_{t} \vert {𝕤}_{t + 1} ) = \{ \begin{matrix}\frac{{( {τ}_{ij} )}^{α} {( {η}_{ij} )}^{β}}{{\sum }_{m ∈ {allowed}_{S}} {( {τ}_{im} )}^{α} {( {η}_{im} )}^{β}} , & j ∈ {allowed}_{S} \\ 0 , & otherwise\end{matrix}$$

where [symbol] ( [symbol] ₜ| [symbol] ₜ₊₁) represents a probability of transfer from the discharge node i to another discharge node j under the action [symbol] ₜ, [symbol] ₜ₊₁ represents a corresponding state when the partial discharge source node j is explored at a t+1^{th} time point in the simulator, τᵢⱼ represents pheromone concentration corresponding to the transfer from the node i to the node j, ηᵢⱼ represents a heuristic function corresponding to the transfer from the node i to the node j, τᵢₘ represents pheromone concentration corresponding to transfer from the node i to a node m contained in allowedₛ, ηᵢₘ represents a heuristic function corresponding to the transfer from the node i to the node m contained in the allowedₛ, α and β respectively represent weights of the pheromone concentration and the heuristic function, and allowedₛ represents a set of non-uniform-grid partial discharge source nodes capable of being selected at a next time point.

Further, a reward function for the transfer from the node i to the node j is

$$ℝ = \frac{1}{\vert {E}_{t}^{′} - {E}_{t} \vert} ,$$

where

$${E}_{t}^{′}$$

represents a measured discharge intensity obtained by processing a full time-domain waveform acquired by a sensor at the t^{th} time point, and Eₜ represents the simulated partial discharge intensity at the t^{th} time point.

Further, the heuristic space parameterization module is configured to map an edge feature

$${e}_{ij}^{l}$$

connecting an i^{th} node and a j^{th} node in an l^{th} layer of a GNN to the heuristic metric η_{θ}; and
convert the state transition model into the location exploration model that is affected by the heuristic metric and requires T-step graph traversal:

$${ℙ}_{{η}_{θ}} ( 𝕊 ) = {\prod }_{t = 1}^{T} {ℙ}_{{η}_{θ}} ( {𝕤}_{t} \vert {𝕤}_{t + 1} )$$

where [symbol] _{ηθ}( [symbol] ) represents the location exploration model, [symbol] ₜ represents a corresponding state when a partial discharge source node i is explored at a t^{th} time point in the simulator, [symbol] ₜ₊₁ represent a corresponding state when the partial discharge source node i is explored at a t+1^{th} time point in the simulator, T represents an exploration cycle, and t=1, 2, . . . , T.

Further, the location searcher further includes a training module configured to:
train the GNN-based heuristic learner by using a gradient strategy, wherein an objective function L(θ) adopted in a training process is as follows:

$$minimize ℒ ( θ ) = {𝔼}_{𝕊 ∼ {ℙ}_{{η}_{θ}} ( \cdot )} [ f ( 𝕊 ) + W f ( NLS ( 𝕊 , f , + ∞ ) ) ]$$

where f(NLS(S,f, +∞)) represents a corresponding objective function for exploring the actual discharge location of the partial discharge source using the neural-guided perturbation-interleaved local search algorithm, W represents a parameter for balancing f( [symbol] ) and the f(NLS( [symbol] ,f,+∞)), [symbol] represents an expected value of exploring the actual discharge location of the partial discharge source under an impact of the heuristic metric ne, S represents a corresponding state space in the process of exploring the actual discharge location of the partial discharge source, and f(·) represents an objective function, where
a gradient of the objective function [symbol] (θ) is ∇L(θ), which is expressed by a following formula:

$$∇ ℒ ( θ ) = {𝔼}_{𝕊 ∼ {ℙ}_{{η}_{θ}} ( \cdot )} [ ( ( f ( 𝕊 ) - \overline{f} ( 𝕊 ) ) + W ( f ( NLS ( 𝕊 , f , + ∞ ) ) - \overline{f} ( NLS ( 𝕊 , f , + ∞ ) ) ) {∇}_{θ} log {P}_{{η}_{θ}} ( 𝕊 ) ]$$

where f̅( [symbol] ) represents an average target value of directly exploring the actual discharge location of the partial discharge source, f(NLS( [symbol] , f, +∞) represents an average target value of exploring the actual discharge location of the partial discharge source using the neural-guided perturbation-interleaved local search algorithm, and ∇_{θ}logP_{ηθ}( [symbol] ) represents a gradient of exploring the actual discharge location of the partial discharge source under the impact of the heuristic metric η_{θ}; and
when a maximum quantity T_{∇} of iterations is reached or the maximum quantity T_{∇}of iterations is not reached but the objective function [symbol] (θ)<v, end the training, where v represents a minimum threshold corresponding to the objective function.

Further, the iterative search module includes:
a local search unit configured to perform the iterative search on the location exploration model by using the local search algorithm, and obtain a local optimal solution;
a perturbation unit configured to perform neural-guided perturbation on the local optimal solution obtained by the current iterative search, and obtain an optimal exploration scheme for the actual discharge location of the partial discharge source in the current iteration through neural-guided perturbation-interleaved local search;
a pheromone concentration updating unit configured to: after all partial discharge source nodes are selected, update pheromone concentration between the partial discharge source nodes; and
an exploration unit configured to determine the optimal exploration scheme for the actual discharge location of the partial discharge source when the iterative search meets an iteration convergence condition, and match the actual discharge location of the partial discharge source based on the optimal exploration scheme.

Further, a process in which the perturbation unit explores the optimal exploration scheme for the actual discharge location of the partial discharge source in the current iteration is expressed by a following formula:

$${𝕊}^{′} = LS ( {𝕊}^{* ′} , \frac{1}{{η}_{θ}} , {T}_{p} )$$

where [symbol] ′ represents the optimal exploration scheme that is for the actual discharge location of the partial discharge source in the current iteration and obtained by performing the neural-guided perturbation on the local optimal solution, [symbol] *′ represents the local optimal solution, Tₚ represents a quantity of perturbation movements, and η_{θ} represents the heuristic metric.

Further, a fault classification module is deployed in the early warning device, and the fault classification module includes:
a deep feature extraction network configured to obtain a deep feature corresponding to an ultra-high frequency (UHF) signal, where the deep feature extraction network includes a feature extraction network and an output network, the feature extraction network is formed by superimposing a plurality of feature extraction layers, and each of the feature extraction layers includes a channel attention module and a spatial attention module that are connected in sequence;
a reinforcement learning unit configured to construct a dataset by using the deep feature, and train, by using a deep reinforcement learning algorithm, a Markov model for feature matching of the partial discharge in the GIS, and obtain an optimal feature matching result of the partial discharge in the GIS; and
an early warning unit configured to generate the early warning information based on the optimal feature matching result of the partial discharge in the GIS and the actual discharge location of the partial discharge source, and perform early fault warning.

The present disclosure further provides a real-time state perception and early warning method based on field-electrical integration for a GIS, where the real-time state perception and early warning method is applied to the above real-time state perception and early warning system based on field-electrical integration for a GIS to issue an early alarm for a GIS fault, and includes:
obtaining a full time-domain waveform diagram including a time-domain waveform diagram and a frequency-domain waveform diagram of a partial discharge signal when detecting, based on pre-screened strongly correlated features, that an electromagnetic field signal inside the GIS contains the partial discharge signal;
performing coarse positioning on a partial discharge source based on the full time-domain waveform diagram of partial discharge in the GIS, performing simulation enhancement calculation by using a coarse positioning result as an initial injection point, and obtaining simulation enhancement data of the partial discharge source;
performing iterative search on a measured discharge intensity calculated based on the full time-domain waveform diagram and a simulation enhancement result, and obtaining an actual discharge location of the partial discharge source; and
issuing an early warning based on the full time-domain waveform diagram and early warning information containing the actual discharge location of the partial discharge source.

The present disclosure has the following advantages:

(1) The present disclosure detects, by using pre-screened strongly correlated features as an indicator, a digital signal converted from an electromagnetic field signal, and acquires a high-precision full time-domain waveform diagram of partial discharge in a GIS when determining that a partial discharge signal is monitored. Then, the present disclosure performs coarse positioning on a partial discharge source based on the full time-domain waveform diagram of the partial discharge in the GIS, and injects a coarse positioning result into a simulator to simulate a partial discharge phenomenon of the GIS and perform simulation enhancement calculation to obtain simulation enhancement data of the partial discharge source, thereby achieving fast and high-precision electromagnetic field simulation of the GIS. Finally, the present disclosure performs iterative search based on the real-time acquired full time-domain waveform diagram and the simulation enhancement data, obtains an actual discharge location of the partial discharge source, and realizes an early warning based on the actual discharge location and other information. Therefore, the present disclosure achieves high-performance real-time state perception and early warning based on field-electrical integration of the GIS.

(2) The present disclosure substitutes various time-domain and frequency-domain features for detecting the electromagnetic field signal into a GNN, and takes the time-domain and frequency-domain features as nodes of the GNN, where a connection line between the nodes represents a correlation between features represented by the nodes. Correlation strength screening is performed through iteration of the GNN, and features with a highest correlation degree, namely strongly correlated features, are obtained. Then, the partial discharge signal is detected based on the obtained strongly correlated features. Although an amount of calculation is reduced, accuracy of detecting the partial discharge signal is not affected because a correlation between indicators is considered. Therefore, the present disclosure improves the accuracy of detecting the partial discharge signal on a premise of greatly reducing the amount of calculation.

(3) Since the electromagnetic field simulation of the GIS focuses more on accurate simulation of detail interaction between a device and an electromagnetic field, the present disclosure designs and constructs a differential deep learning network model. In the differential deep learning network model, convolution combined with a differential algorithm is adopted to process coarse-grid field strength data, which can accurately simulate an electromagnetic field distribution of the GIS, especially in a case of dealing with complex geometric structures and boundary conditions. In addition, a deep learning network is used to optimize a simulation process, improve simulation accuracy, and accelerate the simulation process, thereby effectively shortening design and evaluation cycles, and balancing accuracy and efficiency of electromagnetic simulation of the GIS.

(4) Taking a preliminarily calculated partial discharge source as a center, the present disclosure proposes a heuristic fast iterative search algorithm for optimal matching of a measured value in a neighborhood of the partial discharge source. A problem of fast iterative search for an optimal matching location of a discharge source is input into the GNN, and a corresponding heuristic metric is obtained, which is used as an alternative to an expert-designed heuristic metric. On this basis, an ant colony algorithm is iterated. Local search performed on a constructed solution under an ant colony algorithm framework will yield a better solution. A deep ant colony algorithm uses the GNN to generate the heuristic metric to reduce a demand for expert knowledge. In addition, combined with probabilistic local search, a neural-guided perturbation-interleaved local search method is adopted herein to achieve better performance, thereby ensuring efficient solving and achieving the fast iterative search for the optimal matching location of the discharge source.

Additional aspects and advantages of the present disclosure will be partly provided in the following description, and partly become evident in the following description or understood through the practice of the present disclosure.

### BRIEF DESCRIPTION OF THE DRAWINGS

FIG. 1 is a schematic structural diagram of a real-time state perception and early warning system based on field-electrical integration for a GIS according to Embodiment 1 of the present disclosure;

FIG. 2 is a principal block diagram of an embedded device for synchronous signal acquisition and measurement according to Embodiment 1 of the present disclosure;

FIG. 3 is a schematic flowchart of calculating a full time-domain waveform diagram of a partial discharge signal according to Embodiment 1 of the present disclosure;

FIG. 4 shows a complete feature map of a GNN according to Embodiment 1 of the present disclosure;

FIG. 5 is a schematic diagram of an iteration process of a GNN according to Embodiment 1 of the present disclosure;

FIG. 6 is a principal block diagram of implementing simulation enhancement of an electromagnetic field distribution of a GIS using a finite-difference time-domain (FDTD) method according to Embodiment 2 of the present disclosure;

FIG. 7 is a principal block diagram of implementing simulation enhancement of an electromagnetic field distribution of a GIS using a finite-element time-domain (FETD) method according to Embodiment 3 of the present disclosure;

FIG. 8 is a principal block diagram of enhancing coarse-grid data of an electromagnetic field of a GIS based on a differential network according to Embodiment 4 of the present disclosure;

FIG. 9 is a schematic structural diagram of an enhancement network in a differential deep learning network model according to Embodiment 4 of the present disclosure;

FIG. 10 schematically shows a design principle of a differential convolution module according to Embodiment 4 of the present disclosure;

FIG. 11 is a schematic structural diagram of a structural similarity network in a differential deep learning network model according to Embodiment 4 of the present disclosure;

FIG. 12 is a principal block diagram of enhancing data of electromagnetic field simulation of a GIS based on a projection upsampling generative adversarial network (PU-GAN) according to Embodiment 5 of the present disclosure;

FIG. 13 is a schematic structural diagram of a generator according to Embodiment 5 of the present disclosure;

FIG. 14 is a schematic structural diagram of a feature extraction module according to Embodiment 5 of the present disclosure;

FIG. 15 is a schematic structural diagram of a structural similarity module according to Embodiment 5 of the present disclosure;

FIG. 16 is a schematic structural diagram of a field strength consistency module according to Embodiment 5 of the present disclosure;

FIG. 17 is a schematic structural diagram of a self-attention unit according to Embodiment 5 of the present disclosure;

FIG. 18 is a principal block diagram of matching an optimal location of partial discharge in a GIS based on a deep ant colony algorithm according to Embodiment 6 of the present disclosure;

FIG. 19 schematically shows a process of searching for an optimal location of partial discharge in a GIS based on a deep ant colony algorithm according to Embodiment 6 of the present disclosure;

FIG. 20 schematically shows a process of extracting a feature of partial discharge in a GIS based on deep enhancement learning according to Embodiment 7 of the present disclosure; and

FIG. 21 is a schematic flowchart of a real-time state perception and early warning method based on field-electrical integration for a GIS according to Embodiment 8 of the present disclosure.

### DETAILED DESCRIPTION OF THE EMBODIMENTS

In order to make the objectives, technical solutions, and advantages of the embodiments of the present disclosure clearer, the following clearly and completely describes the technical solutions in the embodiments of the present disclosure with reference to the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

### Embodiment 1

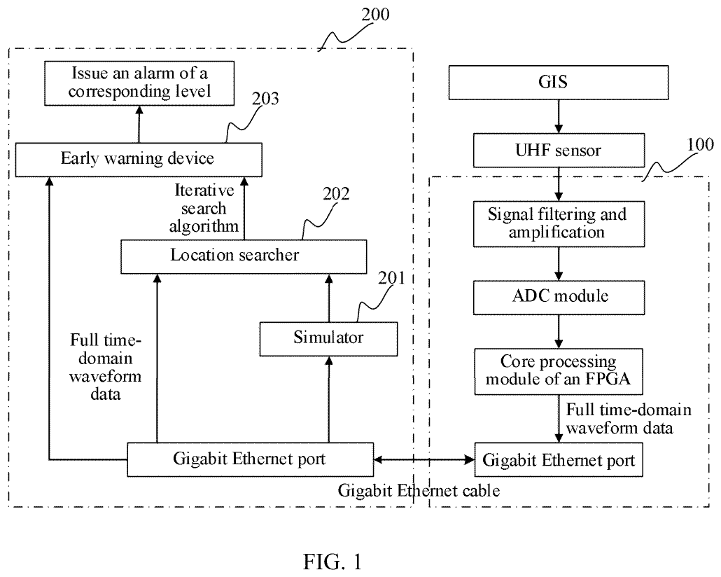

As shown in FIG. 1, Embodiment 1 of the present disclosure proposes a real-time state perception and early warning system based on field-electrical integration for a GIS. The real-time state perception and early warning system includes embedded device 100 for synchronous signal acquisition and measurement and IPC 200. Simulator 201, location searcher 202, and early warning device 203 are deployed in the IPC 200. An output of the embedded device 100 for synchronous signal acquisition and measurement is separately connected to the simulator 201 and the location searcher 202, an output of the simulator 201 is connected to the location searcher 202, and an output of the location searcher 202 is connected to the early warning device 203.

The embedded device 100 for synchronous signal acquisition and measurement is configured to obtain a full time-domain waveform diagram including a time-domain waveform diagram and a frequency-domain waveform diagram of a partial discharge signal when detecting, based on pre-screened strongly correlated features, that an electromagnetic field signal inside the GIS contains the partial discharge signal.

The simulator 201 is configured to perform coarse positioning on a partial discharge source based on the full time-domain waveform diagram of partial discharge in the GIS, perform simulation enhancement calculation by using a coarse positioning result as an initial injection point, and obtain simulation enhancement data of the partial discharge source.

The location searcher 202 is configured to perform iterative search on a measured discharge intensity calculated based on the full time-domain waveform diagram and a simulation enhancement result, and obtain an actual discharge location of the partial discharge source.

The early warning device 203 is configured to issue an early warning based on the full time-domain waveform diagram and early warning information containing the actual discharge location of the partial discharge source.

In this embodiment, a digital signal converted from the electromagnetic field signal is detected by using the pre-screened strongly correlated features as an indicator, and a high-precision full time-domain waveform diagram of the partial discharge in the GIS is acquired when it is determined that the partial discharge signal is monitored. Then, the coarse positioning is performed on the partial discharge source based on the full time-domain waveform diagram of the partial discharge in the GIS, and the coarse positioning result is injected into the simulator to simulate a partial discharge phenomenon of the GIS, and the simulation enhancement calculation is performed to obtain the simulation enhancement data of the partial discharge source, thereby achieving fast and high-precision electromagnetic field simulation of the GIS. Finally, the iterative search is performed based on the real-time acquired full time-domain waveform diagram and the simulation enhancement data, the actual discharge location of the partial discharge source is obtained, and the early warning is realized based on the actual discharge location and other information. Therefore, the present disclosure achieves high-performance real-time state perception and early warning based on field-electrical integration of the GIS.

As a further preferred technical solution, the embedded device for synchronous signal acquisition and measurement includes a signal acquisition location determining module, a signal acquisition module, a signal processing front end, an ADC, and a signal measurement module.

The signal acquisition location determining module is configured to determine an installation location of each sensor in the signal acquisition module.

The signal acquisition module is configured to acquire the electromagnetic field signal inside the GIS.

The signal processing front end is configured to perform signal conditioning on the electromagnetic field signal transmitted by the signal acquisition module, and transmit a conditioned signal to the ADC.

The ADC is configured to convert the conditioned signal from an analog signal to a digital signal and transmit the digital signal to the signal measurement module.

The signal measurement module is configured to monitor the digital signal based on the pre-screened strongly correlated features, and obtain the full time-domain waveform diagram including the time-domain waveform diagram and the frequency-domain waveform diagram of the partial discharge signal when determining that the partial discharge signal is monitored, where the strongly correlated features include time-domain strongly correlated features and frequency-domain strongly correlated features.

In this embodiment, a multi-channel acquisition module is disposed to achieve multi-channel acquisition of the electromagnetic field signal inside the GIS, and the acquired electromagnetic field signal inside the GIS is conditioned to obtain a high-performance electromagnetic field signal. Then, the digital signal converted from the electromagnetic field signal is detected by using the pre-screened strongly correlated features as the indicator. When it is determined that the partial discharge signal is monitored, the time-domain waveform diagram and frequency-domain waveform diagram are respectively obtained based on the time-domain strongly correlated features and the frequency-domain strongly correlated features. The time-domain waveform diagram and the frequency-domain waveform diagram are synthesized to obtain the full time-domain waveform diagram. Therefore, the present disclosure can acquire the high-precision full time-domain waveform diagram of the partial discharge in the GIS.

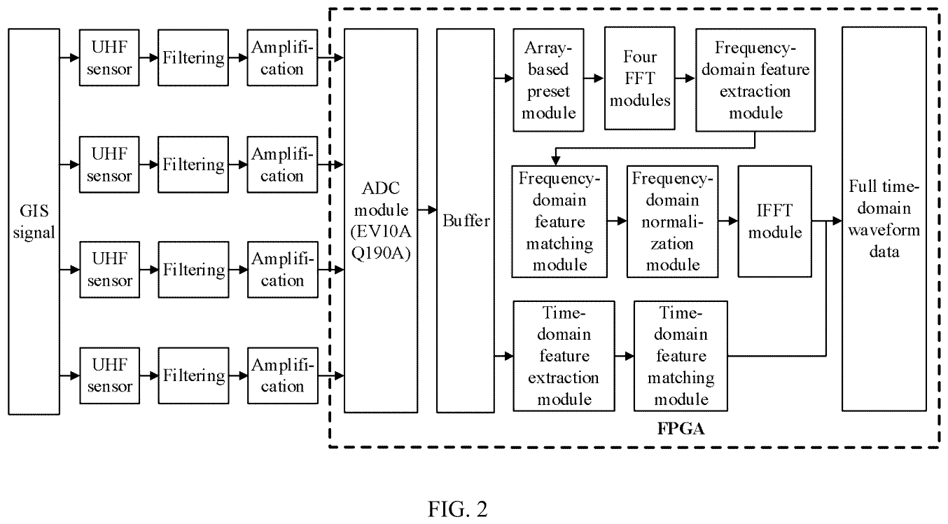

As a further preferred technical solution, as shown in FIG. 2, the signal processing front end includes amplification and filtering circuits equal in quantity to sensors in the signal acquisition module, and the amplification and filtering circuits are connected to the sensors in a one-to-one correspondence.

Each of the amplification and filtering circuits includes a radio frequency (RF) gain circuit, a band-pass filter, and a band-stop filter that are connected in sequence, where a frequency of the band-pass filter ranges from 300 MHz to 1500 MHZ, and a frequency of the band-stop filter ranges from 800 MHz to 1000 MHz.

It should be noted that, in this embodiment, band-pass filtering and band-stop filtering are implemented based on an effective frequency band of a UHF signal inside the GIS and common interference frequency bands, which are more suitable for UHF signal acquisition inside the GIS. The disposed band-pass filter is configured to extract a useful signal in a specific frequency band and filter out an irrelevant interference signal and noise. In addition, a low-noise, wide-band, cascadable, and high-linearity signal amplifier may be connected after the band-stop filter.

As a preferred technical solution, the ADC adopts an ADC chip with a data conversion rate of 4 channels at 4 Gsps or 1 channel at 5 Gsps.

It should be noted that the embedded device for synchronous signal acquisition and measurement in this embodiment can realize acquisition and real-time processing of 4-channel high-speed data at 4 Gsps, and supports multi-channel sampling, enabling simultaneous acquisition of 4-channel data with a signal input range of 1.4 V and 12-bit data at a 4 Gsps sampling rate. Meanwhile, signal processing logic with fixed functions is disposed in a field-programmable gate array (FPGA) to improve parallel rapidity of the system, thereby achieving multi-channel and high-precision acquisition of the electromagnetic field signal inside the GIS.

As a further preferred technical solution, the signal measurement module includes a caching unit, a first monitoring unit, a second monitoring unit, and a waveform synthesis unit.

The caching unit is configured to cache the digital signal.

The first monitoring unit is configured to extract the time-domain strongly correlated features from the digital signal, determine, based on the time-domain strongly correlated features, that the partial discharge signal is monitored, and output a first time-domain waveform diagram during discharge.

The second monitoring unit is configured to extract the frequency-domain strongly correlated features from the digital signal, determine, based on the frequency-domain strongly correlated features, that the partial discharge signal is monitored, and output a frequency-domain waveform diagram during the discharge.

The waveform synthesis unit is configured to obtain the full time-domain waveform diagram of the partial discharge signal based on the first time-domain waveform diagram and the frequency-domain waveform diagram.

As a further preferred technical solution, the first monitoring unit is configured to analyze the time-domain strongly correlated features, determine whether a first discharge threshold is exceeded, and determine that the partial discharge signal is monitored if the first discharge threshold is exceeded, or determine that the partial discharge signal is not monitored if the first discharge threshold is not exceeded.

The second monitoring unit is configured to analyze the frequency-domain strongly correlated features, determine whether a second discharge threshold is exceeded, and determine that the partial discharge signal is monitored if the second discharge threshold is exceeded, or determine that the partial discharge signal is not monitored if the second discharge threshold is not exceeded.

As a further preferred technical solution, if the partial discharge signal is not monitored, the digital signal stored in the caching unit is deleted.

It should be noted that acquired time-domain data is completely sent to a high-performance caching unit (buffer). If it is determined that no UHF signal of the partial discharge is monitored, the detected time-domain data is deleted from the buffer to free up a storage space for time-domain data acquired subsequently.

As a further preferred technical solution, the second monitoring unit includes:
a Fourier transform subunit configured to perform at least two fast Fourier transform operations on the electromagnetic field signal, and obtain frequency-domain data of at least two frequency bands; and
a normalization subunit configured to extract the frequency-domain strongly correlated features from frequency-domain data of each of the at least two frequency bands, perform normalization processing on a frequency-domain waveform corresponding to each of the at least two frequency bands when determining that the frequency-domain data of each of the at least two frequency bands exceeds the second discharge threshold after analyzing and matching the frequency-domain strongly correlated features, and obtain the frequency-domain waveform diagram during the discharge.

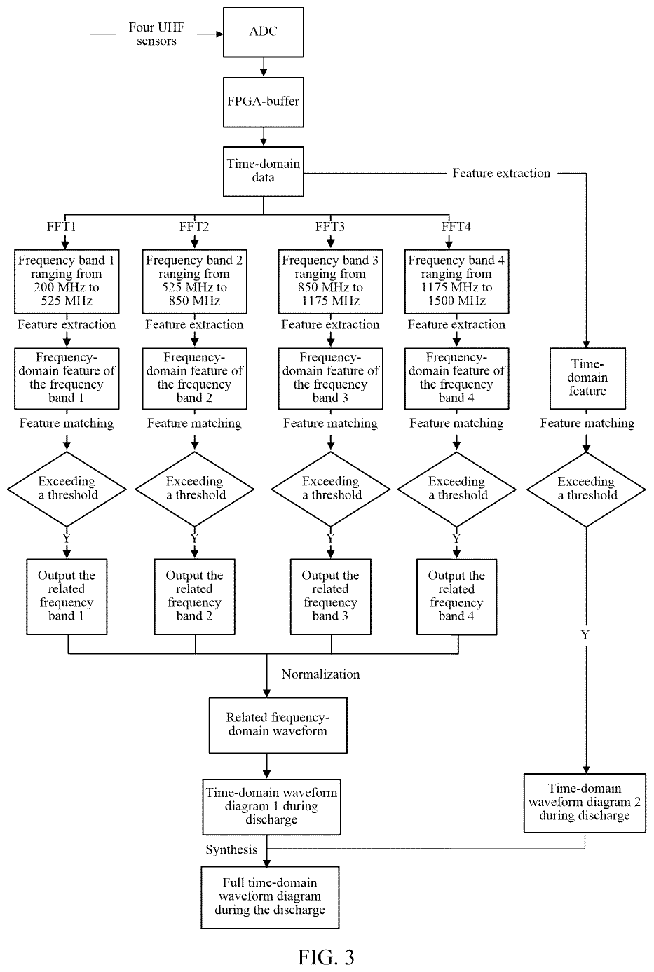

When a large amount of signal data is acquired, direct FFT calculation will result in a low processing speed due to the large data amount, which is not conducive to real-time signal detection and processing. Therefore, the present disclosure adopts array-based processing. As shown in FIG. 3, an FFT result is divided into four frequency bands for parallel processing (the frequency bands are 200 MHz to 525 MHz, 525 MHz to 850 MHZ, 850 MHz to 1175 MHz, and 1175 MHz to 1500 MHz respectively). Correlations of the four frequency bands are calculated separately, such that a plurality of correlation determination criteria are obtained, thereby greatly increasing an amount of information reflecting relative waveform deformation. Meanwhile, changes of a frequency response curve in different frequency intervals caused by different degrees of discharge can be fully reflected. Finally, waveforms of a plurality of frequency bands are fused.

Therefore, an array-based processing mechanism in the present disclosure is a frequency domain segmentation and combination mechanism. Each part in an array only processes a part of a frequency domain, and then processing results are fused together to restore a complete frequency-domain waveform. This mechanism disperses noise signals superimposed in processing the frequency-domain data into segmented parts, reducing stacking of the noise signals. This will help achieve high-sensitivity detection of the UHF signal of the partial discharge.

As a further preferred technical solution, the waveform synthesis unit includes:
a waveform conversion subunit configured to convert the frequency-domain waveform diagram into a second time-domain waveform diagram during the discharge; and
a waveform synthesis subunit configured to synthesize the first time-domain waveform diagram and the second time-domain waveform diagram, and obtain the full time-domain waveform diagram of the partial discharge signal.

Furthermore, in this embodiment, a Xilinx UltraScale+MPSOC FPGA chip is selected to process the digital signal.

It should be noted that this embodiment receives sampled data from the ADC based on the caching unit (buffer), calculates a feature indicator for transmitted time-domain waveform data, and performs data matching. In addition, the FFT is performed to convert a time-domain waveform into a frequency-domain waveform. After the frequency-domain waveform is arrayed, a feature indicator is calculated, and data matching is performed. The obtained frequency-domain waveform is normalized, and upon completion of the normalization, inverse fast Fourier transform (IFFT) is performed to obtain the time-domain waveform. The frequency-domain waveform and the time-domain waveform are then synthesized to output the full time-domain waveform diagram.

This embodiment proposes a frequency-domain arraying method and a real-time digital matching approach, and develops an embedded device based on an ultra-high-speed ADC and an FPGA architecture to synchronously acquire and measure the UHF signal of the partial discharge, thereby obtaining a high-precision full time-domain waveform diagram of the UHF signal of the partial discharge.

It should be noted that, since there are a plurality of time-domain and frequency-domain indicators for detecting the partial discharge signal, if all the time-domain and frequency-domain indicators are calculated to detect the partial discharge signal, theoretically, a detection result will be highly accurate. However, detection and determination based on all the time-domain and frequency-domain indicators will occupy substantial calculation resources. Calculation resources of current hardware cannot handle such a calculation, but randomly selecting some features for calculation alone cannot meet an accuracy requirement.

In this embodiment, the feature screening module is designed to utilize a neural network to select the strongly correlated features for subsequent detection of the partial discharge signal. This significantly reduces a calculation amount and improves accuracy of detecting the partial discharge signal.

Specifically, the time-domain and frequency-domain features include a margin, skewness, a root mean square, a mean, a variance, a peak-to-peak value, a shape factor, kurtosis, an impulse factor, and a C indicator. The frequency-domain features include a mean frequency, frequency concentration, a frequency center, a root-mean-square frequency, and a location change in a main frequency band.

Specifically, the time-domain and frequency-domain features for detecting the partial discharge signal are shown in Table 1:

TABLE 1
Selecting the time-domain and frequency-domain features

| Name | Feature formula |
|---|---|
| Skewness | sₖ = μ₃/σ³ |
| Root mean square | ${x}_{rms} = \sqrt{( {\sum }_{n = 1}^{N} {\vert {x}_{n} \vert}^{2} / N}$ |
| Shape factor | $SF = \sqrt{\overline{{( {x}_{i} )}^{2}}} / \overline{\vert {x}_{i} \vert}$ |
| Kurtosis | $kurtosis = ( {\sum }_{n = 1}^{N} {x}_{i}^{4} ) / ( N * {σ}^{4} )$ |
| Pulse factor | m = (max(x) − min (x))/\|̅x̅\|̅ |
| Margin indicator | L = xₚ/xᵣ |
| C indicator | xₚ/xᵣₘₛ |
| Mean frequency | ${p}_{1} = ( {\sum }_{n = 1}^{N} \vert y \vert ) / k$ |
| Frequency concentration indicator 1 | ${p}_{2} = ( {\sum }_{n = 1}^{N} ( y - {p}_{1} ) ) / k$ |
| Frequency concentration indicator 2 | ${p}_{3} = ( {\sum }_{n = 1}^{N} {( y - {p}_{1} )}^{3} ) / ( k * \sqrt{{p}_{2}^{3}} )$ |
| Frequency concentration indicator 3 | ${p}_{4} = ( {\sum }_{n = 1}^{N} {( y - {p}_{1} )}^{4} ) / ( k * {p}_{2}^{2} )$ |
| Frequency center indicator | ${p}_{5} = ( {\sum }_{n = 1}^{N} fy ) / ( {\sum }_{n = 1}^{N} y )$ |
| Frequency concentration indicator 4 | ${p}_{6} = ( {\sum }_{n = 1}^{N} {( f - {p}_{5} )}^{2} * y ) / k$ |
| Root-mean-square frequency indicator | ${p}_{7} = ( {\sum }_{n = 1}^{N} {f}^{2} * y ) / ( {\sum }_{n = 1}^{N} y )$ |
| Location change indicator 1 of the main frequency band | ${p}_{8} = ( {\sum }_{n = 1}^{N} {f}^{4} * y ) / ( {\sum }_{n = 1}^{N} ( {f}^{2} * y ) )$ |
| Location change indicator 2 of the main frequency band | ${p}_{9} \text{=:} ( {\sum }_{n = 1}^{N} {f}^{4} * y ) / ( {\sum }_{n = 1}^{N} y {\sum }_{n = 1}^{N} ( {f}^{2} * y )$ |
| Frequency concentration | p₁₀ = p₆/p₅ |
| indicator 5 | |
| Frequency concentration indicator 6 | ${p}_{11} = ( {\sum }_{n = 1}^{N} {y ( y - {p}_{5} )}^{3} ) / ( {\sum }_{n = 1}^{N} k * {p}_{6}^{3} )$ |
| Frequency concentration indicator 7 | ${p}_{12} = ( {\sum }_{n = 1}^{N} {y ( y - {p}_{5} )}^{4} ) / ( {\sum }_{n = 1}^{N} k * {p}_{6}^{4} )$ |
| Frequency concentration indicator 8 | ${p}_{13} = ( {\sum }_{n = 1}^{N} \sqrt{y \vert f - {p}_{5} \vert} ) / ( {\sum }_{n = 1}^{N} k * \sqrt{{p}_{6}} )$ |

In the above formulas, L represents the margin indicator, xₚ represents a maximum absolute value (peak value), xᵣ, represents a root square amplitude, sₖ represents the skewness, μ₃ represents a third-order central moment of time-domain waveform data x, σ represents a standard deviation of the time-domain waveform data x, xᵣₘₛ represents the root mean square, xₙ represents an n^{th} piece of time-domain data, N represents a total quantity of time-domain data points, SF represents the shape factor, xᵢ represents a deviation, kurtosis represents the kurtosis, m represents the pulse factor, x represents the time-domain waveform data, p₁ represents the mean frequency, y represents an amplitude of each frequency on a spectrum, k represents a fixed coefficient, which is used to adjust a ratio in the formulas, p₂ represents the frequency concentration indicator 1, p₃ represents the frequency concentration indicator 2, p₄ represents the frequency concentration indicator 3, p₅ represents the frequency center indicator, f represents a frequency of each point on the spectrum, p₆ represents the frequency concentration indicator 4, p₇ represents the root-mean-square frequency indicator, p₈ represents the location change indicator 1 of the main frequency band, p₉ represents the location change indicator 2 of the main frequency band, p₁₀ represents the frequency concentration indicator 5, p₁₁ represents the frequency concentration indicator 6, p₁₂ represents the frequency concentration indicator 7, p₁₄ represents the frequency concentration indicator 8, and * represents a multiplication sign.

It should be noted that the indicators listed in Table 1 are common time-domain and frequency-domain indicators. Some of them contain some characteristics of a UHF and are typical UHF signal indicators. These feature indicators all contain more or less some information that can be used to detect the UHF signa. However, such information may be redundantly present or complementary among a plurality of features. Therefore, in this embodiment, strongly correlated indicators among these feature indicators are screened out by means of the GNN.

As a further preferred technical solution, the feature screening module includes:
a feature map construction unit configured to set xᵥ, x_{co[v]}, h_{ne[v]}, x_{ne[v]} to respectively represent a feature vector of node v, a feature vector of an edge, a state vector of the node v and a neighboring node of the node v, and a feature vector of the neighboring node of the node v in complete feature map G=(V, E) of the GNN, where V represents a node set, and E represents an edge set;
an aggregation updating unit configured to perform aggregation updating on input node and edge information based on a local transition function for updating a node state, and output a node label, which is expressed by the following formula:

$${h}_{v} = f ( {x}_{v} , {x}_{co [ v ]} , {h}_{ne [ v ]} , {x}_{ne [ v ]} )$$

$${o}_{v} = g ( {h}_{v} , {x}_{v} )$$

where f(·) represents the local transition function for updating the node state, g(.) represents a local output function, hᵥ represents a state vector learned through iterative learning of the GNN, and oᵥ represents the node label; and
an iteration unit configured to calculate a correlation between a node and an adjacent node during continuous iteration of the GNN, and obtain the time-domain strongly correlated features and the frequency-domain strongly correlated features.

As a further preferred technical solution, the iteration unit is specifically configured to:
respectively set H, O, X, and X_{N} to a vector constructed by superimposing state vectors of all the nodes, a vector constructed by superimposing all output labels, a vector constructed by superimposing feature vectors of all the nodes and all edges, and a vector constructed by superimposing feature vectors of all the nodes, and write formulas in a more compact form as follows:

$$O = G ( H , {X}_{N} )$$

$${H}^{t + 1} = F ( {H}^{t} , X )$$

where H^{t} represents a t^{th} iteration of the H, H^{t+1}=F(H^{t}, X) represents an operation of obtaining state vectors of all the nodes in a t+1^{th} iteration based on a feature vector and a state vector of the t^{th} iteration through a global transition function, and F(.) and G(.) respectively represent the global transition function and a global output function, which are respectively obtained by stacking local transition functions f(·) and local output functions g(.) of all the nodes; and
in an iteration process, determine nodes with similar states, nodes with complementary states, and overall impacts of all the nodes on the GNN, and take one node selected from the nodes with similar states, one node merged from the nodes with complementary states, and a node with a greatest overall impact on the GNN as the strongly correlated features.

It should be noted that the feature vector of the node is an inherent state of the node, which does not change in the iteration process of the GNN. In this embodiment, the feature vector is specifically a parameter indicator in a formula for calculating the time-domain and frequency-domain features of the electromagnetic field signal, such as the standard deviation or the peak value. The feature vector of the edge is a connection between two nodes. Specifically, in this embodiment, the feature vector refers to same parameter indicators or similar processing procedures of the nodes in the calculation formula. Connecting these similar feature nodes together helps a model learn a relationship and a mutual impact between these features. The state vector is a continuously updated node vector obtained through calculation in the iteration process. The node label is a target value used for a supervised learning task. In this embodiment, each node represents a signal feature, and there is a corresponding label to indicate a category and a state of the signal feature.

In this embodiment, the GNN is used to calculate a connection between a node and an adjacent node. Through a plurality of iterations, a correlation between the node and an adjacent node of the adjacent node of the node can also be found, which is very suitable for screening the strongly correlated features. In this embodiment, all features of time-domain and frequency-domain signals of the partial discharge in the GIS (as shown in Table 1 above) are imported into the GNN as nodes in the network, and the constructed complete feature map is shown in FIG. 4. In FIG. 4, each node represents a single feature, and a connection line between the nodes represents a relationship between features represented by the nodes. Some features have a strong correlation, for example, both p₂ and p₃ contain p₁. However, some features have a weak correlation, and are not connected. A blank node represents a feature that has no significant correlation with other features.

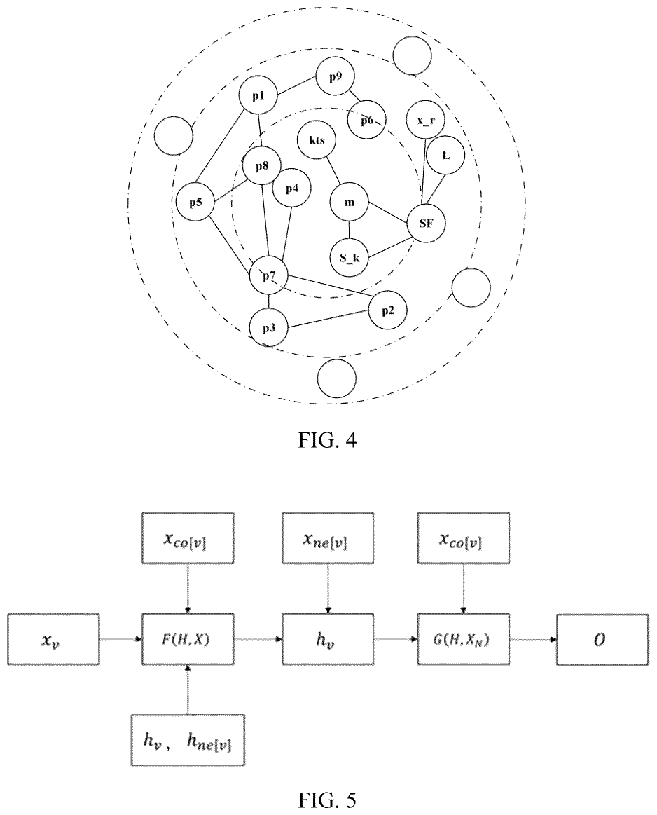

As shown in FIG. 5, in the iteration process of the GNN, a feature vector inherent to the node itself does not change with the iteration of the network, but a state vector between the nodes changes with the iteration of the GNN. Therefore, the GNN can be used to calculate a connection between a node and an adjacent node, and through a plurality of iterations, a connection between the node and an adjacent node of the adjacent node of the node can also be found. Through the continuous iteration of the GNN, it can be found that states of some nodes in the GNN become more and more similar, states of some nodes are complementary, and overall impacts of some nodes on the GNN become smaller. One of the similar nodes is selected, the complementary nodes are merged to one node, and then the node with the greatest overall impact on the system is selected, that is, the strongly correlated features of the system are obtained.

The GNN adopted in this embodiment pre-constrains the model through a loss function, and finally uses a gradient descent algorithm to minimize a loss, thereby obtaining optimal parameters of the network model and a trained GNN. In this embodiment, the features in Table 1 above are substituted into the GNN for correlation strength screening, and features with a strongest correlation are obtained, that is, the strongly correlated features are the root mean square, the pulse factor, and the margin indicator in a time domain, as well as the root-mean-square frequency indicator, the location change indicator 1 of the main frequency band, and the location change indicator 2 of the main frequency band in the frequency domain. Then, the partial discharge signal is detected based on these screened strongly correlated features. Although an amount of calculation is reduced, the accuracy of detecting the partial discharge signal is not affected because a correlation between indicators is considered. Therefore, the present disclosure improves the accuracy of detecting the partial discharge signal on a premise of greatly reducing the amount of calculation.

### Embodiment 2

Based on the content disclosed in Embodiment 1, a process in which the simulator implements simulation enhancement of an electromagnetic field distribution of the GIS using an FDTD method in Embodiment 1 is described in detail. The simulator includes:
a simulation module configured to take the coarse positioning result that is of the partial discharge source and obtained based on the full time-domain waveform diagram as an initial injection point of a three-dimensional simulation model of the GIS to simulate a partial discharge phenomenon of the GIS, and perform simulation calculation to obtain a coarse-grid simulation result; and
an enhancement module configured to enhance the coarse-grid simulation result by using an enhancement model, and obtain the simulation enhancement data.

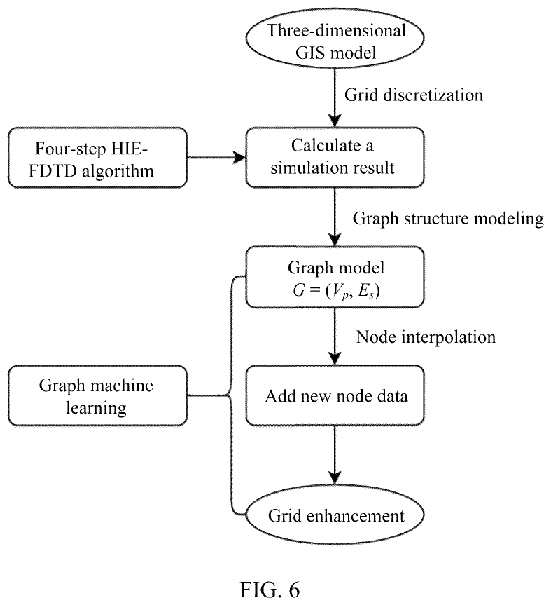

As a further preferred technical solution, as shown in FIG. 6, the simulation module includes:
a spatial discretization unit configured to discretize the three-dimensional simulation model of the GIS into spatial grids, and determine a corresponding relationship between a number and spatial coordinate data of each grid node; and
a differential simulation unit configured to inject the coarse positioning result into a corresponding spatial grid as the initial injection point to simulate the partial discharge phenomenon of the GIS, convert a Maxwell's equation describing an electromagnetic field of the GIS into a fourth-order matrix, solve the fourth-order matrix by using a four-step HIE-FDTD algorithm, and calculate field strength data of each grid node.

As a further preferred technical solution, the differential simulation unit includes a matrix reconstruction subunit, a matrix conversion subunit, and a solving subunit.

The matrix reconstruction subunit is configured to convert the Maxwell's equation describing the electromagnetic field of the GIS into a form of a sixth-order matrix:

$$\frac{\partial \vec{u}}{\partial t} = [ M ] \vec{u}$$

where \vec{u} represents a vector composed of components of an electric field and a magnetic field in a rectangular coordinate system, and u=[Eₓ, E_{y}, E_{z}, Hₓ, H_{y}, H_{z}]^{T}, where

$$\frac{\partial {H}_{x}}{\partial t} = \frac{1}{u} ( \frac{\partial {E}_{y}}{\partial z} - \frac{\partial {E}_{z}}{\partial y} - ρ {H}_{x} )$$

$$\frac{\partial {H}_{y}}{\partial t} = \frac{1}{u} ( \frac{\partial {E}_{z}}{\partial x} - \frac{\partial {E}_{x}}{\partial z} - ρ {H}_{y} )$$

$$\frac{\partial {H}_{z}}{\partial t} = \frac{1}{u} ( \frac{\partial {E}_{x}}{\partial y} - \frac{\partial {E}_{y}}{\partial x} - ρ {H}_{z} )$$

$$\frac{\partial {E}_{x}}{\partial t} = \frac{1}{ε} ( \frac{\partial {H}_{z}}{\partial y} - \frac{\partial {H}_{y}}{\partial x} - σ {E}_{x} )$$

$$\frac{\partial {E}_{y}}{\partial t} = \frac{1}{ε} ( \frac{\partial {H}_{x}}{\partial z} - \frac{\partial {H}_{z}}{\partial x} - σ {E}_{y} )$$

$$\frac{\partial {E}_{z}}{\partial t} = \frac{1}{ε} ( \frac{\partial {H}_{y}}{\partial x} - \frac{\partial {H}_{x}}{\partial y} - σ {E}_{z} )$$

[M] represents the sixth-order matrix, which is expressed as follows:

$$[ M ] = [ \begin{matrix}0 & 0 & 0 & 0 & - \frac{1}{ε} \frac{\partial }{\partial z} & \frac{1}{ε} \frac{\partial }{\partial y} \\ 0 & 0 & 0 & \frac{1}{ε} \frac{\partial }{\partial z} & 0 & - \frac{1}{ε} \frac{\partial }{\partial x} \\ 0 & 0 & 0 & - \frac{1}{ε} \frac{\partial }{\partial y} & \frac{1}{ε} \frac{\partial }{\partial x} & 0 \\ 0 & \frac{1}{μ} \frac{\partial }{\partial z} & - \frac{1}{μ} \frac{\partial }{\partial y} & 0 & 0 & 0 \\ - \frac{1}{μ} \frac{\partial }{\partial z} & 0 & \frac{1}{μ} \frac{\partial }{\partial x} & 0 & 0 & 0 \\ \frac{1}{μ} \frac{\partial }{\partial y} & - \frac{1}{μ} \frac{\partial }{\partial x} & 0 & 0 & 0 & 0\end{matrix} ]$$

In the above formula, ε represents a dielectric constant, and μ represents a magnetic permeability.

It should be noted that this embodiment represents a Maxwell's equation set in a matrix form, which enables a component of the electromagnetic field to be expressed in a vector form, while a differential operation in an equation is described by a matrix operation. This form provides a more unified and compact description method, such that the equation set can be understood and derived more easily. Moreover, in a numerical solving process, numerical methods usually involve solving a discretized equation set, and the matrix form makes these solving methods more direct and effective.

The matrix conversion subunit is configured to convert the form of the sixth-order matrix into the form of the fourth-order matrix:

$$\frac{\partial \vec{u}}{\partial t} = \frac{[ {A}_{H} ]}{2} \vec{u} + \frac{[ {B}_{H} ]}{2} \vec{u} + \frac{[ {A}_{H} ]}{2} \vec{u} + \frac{[ {B}_{H} ]}{2} \vec{u}$$

where [A_{H}] and [B_{H}] are respectively expressed as follows:

$$[ {A}_{H} ] = [ \begin{matrix}0 & 0 & 0 & 0 & 0 & \frac{1}{ε} \frac{\partial }{\partial y} \\ 0 & 0 & 0 & \frac{1}{ε} \frac{\partial }{\partial z} & 0 & 0 \\ 0 & 0 & 0 & 0 & \frac{1}{ε} \frac{\partial }{\partial x} & 0 \\ 0 & \frac{1}{μ} \frac{\partial }{\partial z} & 0 & 0 & 0 & 0 \\ 0 & 0 & \frac{1}{μ} \frac{\partial }{\partial x} & 0 & 0 & 0 \\ \frac{1}{μ} \frac{\partial }{\partial y} & 0 & 0 & 0 & 0 & 0\end{matrix} ]$$

$$[ {B}_{H} ] = [ \begin{matrix}0 & 0 & 0 & 0 & - \frac{1}{ε} \frac{\partial }{\partial z} & 0 \\ 0 & 0 & 0 & 0 & 0 & - \frac{1}{ε} \frac{\partial }{\partial x} \\ 0 & 0 & 0 & - \frac{1}{ε} \frac{\partial }{\partial y} & 0 & 0 \\ 0 & 0 & - \frac{1}{μ} \frac{\partial }{\partial y} & 0 & 0 & 0 \\ - \frac{1}{μ} \frac{\partial }{\partial z} & 0 & 0 & 0 & 0 & 0 \\ 0 & - \frac{1}{μ} \frac{\partial }{\partial x} & 0 & 0 & 0 & 0\end{matrix} ]$$

The solving subunit is configured to solve the form of the fourth-order matrix by using the four-step HIE-FDTD algorithm, and calculate the field strength data of each grid node.

In this embodiment, higher-order temporal and spatial integration schemes are introduced, which can significantly improve accuracy and stability of a numerical solution. Traditional FDTD methods may be affected by numerical dissipation and numerical dispersion, while the present disclosure can mitigate these problems through a more accurate integration method, which is particularly effective when dealing with long-term simulation or high-frequency electromagnetic wave propagation. For structurally complicated electromagnetic field simulation, which involves, for example, a medium, an inhomogeneous medium, or an inhomogeneous structure, this embodiment adopts the four-step HIE-FDTD method to better handle such complexities. Precise integration and numerical methods in this embodiment can effectively simulate electromagnetic field propagation and interaction between different media.

As a further preferred technical solution, the solving subunit is configured to perform the following steps:

The four-step HIE-FDTD algorithm is decomposed into four sub-steps in the time domain, namely n→n+¼, n+¼→n+2/4, n+2/4→n+¾, and n+¾→n+1, and for each of the sub-steps, a semi-implicit difference scheme is used to calculate a tridiagonal implicit form of the field strength data of the grid node.

The tridiagonal implicit form is solved by using a chasing method, and the field strength data of the grid node is obtained.

Specifically, the four-step HIE-FDTD algorithm is decomposed into the sub-steps n→n+¼, n+¼→n+2/4, n+2/4→n+¾, and n+¾→n+1 in the time domain, where

$$Sub - step n \to n + 1 / 4 : ( [ I ] - \frac{Δ t}{4} [ {A}_{H} ] ) {\vec{u}}^{n + 1 / 4} = ( [ I ] + \frac{Δ t}{4} [ {B}_{H} ] ) {\vec{u}}^{n} - \frac{Δ t}{4 ε} \times \frac{1}{2} ( {\overline{J}}^{n} + {\overline{J}}^{n + 1 / 4} ) \qquad ( 1 )$$

$$Sub - step n + 1 / 4 \to n + 2 / 4 : ( [ I ] - \frac{Δ t}{4} [ {B}_{H} ] ) {\vec{u}}^{n + 2 / 4} = ( [ I ] + \frac{Δ t}{4} [ {A}_{H} ] ) {\vec{u}}^{n + 1 / 4} - \frac{Δ t}{4 ε} \times \frac{1}{2} ( {\overline{J}}^{n + 1 / 4} + {\overline{J}}^{n + 2 / 4} ) \qquad ( 2 )$$

$$Sub - step n + 2 / 4 \to n + 3 / 4 : ( [ I ] - \frac{Δ t}{4} [ {A}_{H} ] ) {\vec{u}}^{n + 3 / 4} = ( [ I ] + \frac{Δ t}{4} [ {B}_{H} ] ) {\vec{u}}^{n + 2 / 4} - \frac{Δ t}{4 ε} \times \frac{1}{2} ( {\overline{J}}^{n + 3 / 4} + {\overline{J}}^{n + 2 / 4} ) \qquad ( 3 )$$

$$Sub - step n + 3 / 4 \to n + 1 : ( [ I ] - \frac{Δ t}{4} [ {B}_{H} ] ) {\vec{u}}^{n + 1} = ( [ I ] + \frac{Δ t}{4} [ {A}_{H} ] ) {\vec{u}}^{n + 3 / 4} - \frac{Δ t}{4 ε} \times \frac{1}{2} ( {\overline{J}}^{n + 1} + {\overline{J}}^{n + 3 / 4} ) \qquad ( 4 )$$

For the sub-step n→n+1/4, the semi-implicit difference scheme is adopted to introduce auxiliary vector

$${\vec{J}}^{n} = {σ [ {E}_{x}^{n} , {E}_{y}^{n} , {E}_{z}^{n} , 0 , 0 , 0 ]}^{T} ,$$

which keeps a stability condition of the algorithm unchanged, and it can be obtained that:

$$( 1 + \frac{b}{4} σ ) {E}_{x}^{n + 1 / 4} - \frac{b}{2} \frac{\partial }{\partial y} {H}_{z}^{n + 1 / 4} = ( 1 - \frac{b}{4} σ ) {E}_{x}^{n} - \frac{b}{2} \frac{\partial }{\partial z} {H}_{y}^{n}$$

$$( 1 + \frac{b}{4} σ ) {E}_{y}^{n + 1 / 4} + \frac{b}{2} \frac{\partial }{\partial x} {H}_{z}^{n + 1 / 4} = ( 1 - \frac{b}{4} σ ) {E}_{y}^{n} + \frac{b}{2} \frac{\partial }{\partial z} {H}_{x}^{n}$$

$$( 1 + \frac{b}{4} σ ) {E}_{z}^{n + 1 / 4} - \frac{b}{2} \frac{\partial }{\partial x} {H}_{y}^{n + 1 / 4} = ( 1 - \frac{b}{4} σ ) {E}_{z}^{n} - \frac{b}{2} \frac{\partial }{\partial y} {H}_{x}^{n}$$

$${H}_{x}^{n + 1 / 4} - \frac{d}{2} \frac{\partial }{\partial z} {E}_{y}^{n + 1 / 4} == {H}_{x}^{n} - \frac{d}{2} \frac{\partial }{\partial y} {E}_{z}^{n}$$

$${H}_{y}^{n + 1 / 4} + \frac{d}{2} \frac{\partial }{\partial z} {E}_{x}^{n + 1 / 4} = {H}_{y}^{n} + \frac{d}{2} \frac{\partial }{\partial x} {E}_{z}^{n}$$

$${H}_{z}^{n + 1 / 4} - \frac{d}{2} \frac{\partial }{\partial y} {E}_{x}^{n + 1 / 4} = {H}_{z}^{n} - \frac{d}{2} \frac{\partial }{\partial x} {E}_{y}^{n}$$

As described above, the

$$( 1 + \frac{b}{4} σ ) {E}_{x}^{n + \frac{1}{4}} - \frac{b}{2} \frac{\partial }{\partial y} {H}_{z}^{n + \frac{1}{4}} = ( 1 - \frac{b}{4} σ ) {E}_{x}^{n} - \frac{b}{2} \frac{\partial }{\partial y} {H}_{y}^{n} and$$

$$the ( 1 + \frac{b}{4} σ ) {E}_{y}^{n + 1 / 4} + \frac{b}{2} \frac{\partial }{\partial x} {H}_{z}^{n + 1 / 4} = ( 1 - \frac{b}{4} σ ) {E}_{y}^{n} + \frac{b}{2} \frac{\partial }{\partial z} {H}_{x}^{n}$$

are coupled equations, and a tridiagonal implicit equation of the

$${E}_{z}^{n + 1 / 4}$$

is eliminated by using a substitution method as follows:

$$( 1 + \frac{b}{4} σ - \frac{bd}{4} \frac{{\partial }^{2}}{\partial {y}^{2}} ) {E}_{x}^{n + 1 / 4} = ( 1 - \frac{b}{4} σ ) {E}_{x}^{n} - \frac{b}{2} \frac{\partial }{\partial z} {H}_{y}^{n} + \frac{b}{2} \frac{\partial }{\partial y} {H}_{z}^{n} - \frac{bd}{4} \frac{{\partial }^{2}}{\partial x \partial y} {E}_{y}^{n}$$

In the above formula, σ represents a point loss parameter of the medium,

$$b = \frac{Δ t}{2 ε} ,$$

$$d = \frac{Δ t}{2 μ} ,$$

Δt represents a time step size, Eₓ, E_{y}, E_{z} represent components of the electric field in x, y, and z directions, Hₓ, H_{y}, H_{z} represent components of the magnetic field in the x, y, and z directions, the superscript represents a time step, for example,

$${E}_{x}^{n}$$

represents Ex at time step n,

$${E}_{x}^{n + 1 / 4}$$

represents the electric field Ex at a ¼ location between time steps n and n+1, and [I] represents a sixth-order unit matrix.

For the sub-step n+¼→n+2/4, an expression of the auxiliary vector \vec{j}ⁿ is substituted and expanded, and it is obtained that:

$$( 1 + \frac{b}{4} σ ) {E}_{x}^{n + 2 / 4} - \frac{b}{2} \frac{\partial }{\partial y} {H}_{z}^{n + 2 / 4} = ( 1 - \frac{b}{4} σ ) {E}_{x}^{n + 1 / 4} - \frac{b}{2} \frac{\partial }{\partial z} {H}_{y}^{n + 1 / 4}$$

$$( 1 + \frac{b}{4} σ ) {E}_{y}^{n + 2 / 4} + \frac{b}{2} \frac{\partial }{\partial x} {H}_{z}^{n + 2 / 4} = ( 1 - \frac{b}{4} σ ) {E}_{y}^{n + 1 / 4} + \frac{b}{2} \frac{\partial }{\partial z} {H}_{x}^{n + 1 / 4}$$

$$( 1 + \frac{b}{4} σ ) {E}_{z}^{n + 2 / 4} - \frac{b}{2} \frac{\partial }{\partial x} {H}_{y}^{n + 2 / 4} = ( 1 - \frac{b}{4} σ ) {E}_{z}^{n + 1 / 4} - \frac{b}{2} \frac{\partial }{\partial y} {H}_{x}^{n + 1 / 4}$$

$${H}_{x}^{n + 2 / 4} - \frac{d}{2} \frac{\partial }{\partial z} {E}_{y}^{n + 2 / 4} = {H}_{x}^{n + 1 / 4} - \frac{d}{2} \frac{\partial }{\partial y} {E}_{z}^{n + 1 / 4}$$

$${H}_{y}^{n + 2 / 4} + \frac{d}{2} \frac{\partial }{\partial z} {E}_{x}^{n + 2 / 4} = {H}_{y}^{n + 1 / 4} + \frac{d}{2} \frac{\partial }{\partial x} {E}_{z}^{n + 1 / 4}$$

$${H}_{z}^{n + 2 / 4} - \frac{d}{2} \frac{\partial }{\partial y} {E}_{x}^{n + 2 / 4} = {H}_{z}^{n + 1 / 4} - \frac{d}{2} \frac{\partial }{\partial x} {E}_{y}^{n + 1 / 4}$$

For the sub-step n+2/4→n+¾, the expression of the auxiliary vector In is substituted and expanded, and it is obtained that:

$$( 1 + \frac{b}{4} σ ) {E}_{x}^{n + 3 / 4} - \frac{b}{2} \frac{\partial }{\partial y} {H}_{z}^{n + 3 / 4} = ( 1 - \frac{b}{4} σ ) {E}_{x}^{n + 2 / 4} - \frac{b}{2} \frac{\partial }{\partial z} {H}_{y}^{n + 2 / 4}$$

$$( 1 + \frac{b}{4} σ ) {E}_{y}^{n + 3 / 4} + \frac{b}{2} \frac{\partial }{\partial x} {H}_{z}^{n + 3 / 4} = ( 1 - \frac{b}{4} σ ) {E}_{y}^{n + 2 / 4} + \frac{b}{2} \frac{\partial }{\partial z} {H}_{x}^{n + 2 / 4}$$

$$( 1 + \frac{b}{4} σ ) {E}_{z}^{n + 3 / 4} - \frac{b}{2} \frac{\partial }{\partial x} {H}_{y}^{n + 3 / 4} = ( 1 - \frac{b}{4} σ ) {E}_{z}^{n + 2 / 4} - \frac{b}{2} \frac{\partial }{\partial y} {H}_{x}^{n + 2 / 4}$$

$${H}_{x}^{n + 3 / 4} - \frac{d}{2} \frac{\partial }{\partial z} {E}_{y}^{n + 3 / 4} = {H}_{x}^{n2 / 4} - \frac{d}{2} \frac{\partial }{\partial y} {E}_{z}^{n + 2 / 4}$$

$${H}_{y}^{n + 3 / 4} + \frac{d}{2} \frac{\partial }{\partial z} {E}_{x}^{n + 3 / 4} = {H}_{y}^{n2 / 4} + \frac{d}{2} \frac{\partial }{\partial x} {E}_{z}^{n + 2 / 4}$$

$${H}_{z}^{n + 3 / 4} - \frac{d}{2} \frac{\partial }{\partial y} {E}_{x}^{n + 3 / 4} = {H}_{z}^{n2 / 4} - \frac{d}{2} \frac{\partial }{\partial x} {E}_{y}^{n + 2 / 4}$$

For the sub-step n+¾→n+1, the expression of the auxiliary vector jn is substituted and expanded, and it is obtained that:

$$( 1 + \frac{b}{4} σ ) {E}_{x}^{n + 1} - \frac{b}{2} \frac{\partial }{\partial y} {H}_{z}^{n + 1} = ( 1 - \frac{b}{4} σ ) {E}_{x}^{n + 3 / 4} - \frac{b}{2} \frac{\partial }{\partial z} {H}_{y}^{n + 3 / 4}$$

$$( 1 + \frac{b}{4} σ ) {E}_{y}^{n + 1} + \frac{b}{2} \frac{\partial }{\partial x} {H}_{z}^{n + 1} = ( 1 - \frac{b}{4} σ ) {E}_{y}^{n + 3 / 4} + \frac{b}{2} \frac{\partial }{\partial z} {H}_{x}^{n + 3 / 4}$$

$$( 1 + \frac{b}{4} σ ) {E}_{z}^{n + 1} - \frac{b}{2} \frac{\partial }{\partial x} {H}_{y}^{n + 1} = ( 1 - \frac{b}{4} σ ) {E}_{z}^{n + 3 / 4} - \frac{b}{2} \frac{\partial }{\partial y} {H}_{x}^{n + 3 / 4}$$

$${H}_{x}^{n + 1} - \frac{d}{2} \frac{\partial }{\partial z} {E}_{y}^{n + 1} = {H}_{x}^{n 2 / 4} - \frac{d}{2} \frac{\partial }{\partial y} {E}_{z}^{n + 3 / 4}$$

$${H}_{y}^{n + 1} + \frac{d}{2} \frac{\partial }{\partial z} {E}_{x}^{n + 1} = {H}_{y}^{n 2 / 4} + \frac{d}{2} \frac{\partial }{\partial x} {E}_{z}^{n + 3 / 4}$$

$${H}_{z}^{n + 1} - \frac{d}{2} \frac{\partial }{\partial y} {E}_{x}^{n + 1} = {H}_{z}^{n 2 / 4} - \frac{d}{2} \frac{\partial }{\partial x} {E}_{y}^{n + 3 / 4}$$

According to the above equations, components of the electric field and the magnetic field in the x, y, and z directions in each sub-step can be calculated.

This embodiment introduces higher-order temporal and spatial integration schemes, which can significantly enhance accuracy and stability of a numerical solution. Traditional FDTD methods may be affected by numerical dissipation and numerical dispersion, while the present disclosure can mitigate these problems through a more accurate integration method, which is particularly effective when dealing with long-term simulation or high-frequency electromagnetic wave propagation. For a structurally complicated electromagnetic field simulation, which involves, for example, a medium, an inhomogeneous medium, or an inhomogeneous structure, this embodiment adopts the four-step HIE-FDTD method to better handle such complexities. Precise integration and numerical methods in this embodiment can effectively simulate electromagnetic field propagation and interaction between different media.

It should be noted that, in this embodiment, a simulation calculation result can be obtained through calculation. The result is presented as spatial coordinates corresponding to each grid node and distribution data of the electromagnetic field in the grid node. Since fineness of simulation grid division is directly proportional to calculation accuracy and inversely proportional to calculation time, in order to resolve a contradiction between the accuracy and the time, a real-time enhanced grid data simulation method is designed. Based on graph machine learning, grid enhancement is achieved for an electromagnetic field distribution result of coarse-grid simulation, and at the same time, a result of fine-grid simulation is also achieved. Further, in an enhancement module configured to enhance the coarse-grid simulation result by using an enhancement model and obtain the simulation enhancement data, specifically:

A synthetic node is created by combining existing nodes through node interpolation, which is a generation enhancement strategy that generates a new sample through interpolation between a sample of a minority class and its nearest neighbor sample. A training distribution is as follows:

$$\hat{x} = ( 1 - λ ) \cdot {x}_{i} + λ \cdot {x}_{j}$$

$$\hat{y} = ( 1 - λ ) \cdot {y}_{i} + λ \cdot {y}_{j}$$

$$\hat{z} = ( 1 - λ ) \cdot {z}_{i} + λ \cdot {z}_{j}$$

In the above formulas, (xᵢ, yᵢ, zⱼ) and (xⱼ, yⱼ, zⱼ) represent two adjacent grid nodes, which are both from Vₚ, (x, y, y) represents the new grid node, and λ∈[0,1]. That is, the new node (x, y, y) is generated between the node (xᵢ, yᵢ, zⱼ) and the node (xⱼ, yⱼ, zⱼ), and a location of the new node is determined by a value of the λ.

As a further preferred technical solution, field strength data of the new grid node is as follows:

$$E = ( 1 - Δ ) \cdot {E}_{i} + Δ \cdot {E}_{j}$$

$$H = ( 1 - Δ ) \cdot {H}_{i} + Δ \cdot {H}_{j}$$

In the above formulas, (Eᵢ, Hᵢ) and (Eⱼ, Hⱼ) represent field strength data of the two adjacent grid nodes, (E, H) represents the field strength data of the new grid node, and Δ represents an undetermined coefficient. The Δ is determined by the λ and a field strength attribute relationship between the two nodes, and its specific value needs to be confirmed in combination with corresponding field strength, because a gradient of a distance change is different from that of a field strength change.

In this way, a new node can be generated between adjacent nodes, and a feature value of the new node also includes spatial data and field strength data, thereby realizing the grid enhancement for the electromagnetic field distribution result of the coarse-grid simulation and also achieving the result of the fine-grid simulation.

It should be noted that, in this embodiment, a node proliferation algorithm based on the adjacent nodes involves spatial data and electromagnetic field data of the existing nodes. Grid data in GIS simulation has obvious topology characteristics. This embodiment can effectively capture a relationship between grids and retain topology information of the grid data. In addition, the algorithm in this embodiment generates a representation of the new node based on features of the adjacent nodes, enabling the algorithm to take into account a local feature of the node. Furthermore, this embodiment implements graph structure-based algorithm enhancement for simulated coarse-grid data, which can adapt to grid data of different scales, including small-scale and large-scale grids, and is also applicable to GIS simulation data of different equipment under different voltage levels. This enhances the GIS simulation data and improves quality of the grid data.

### Embodiment 3

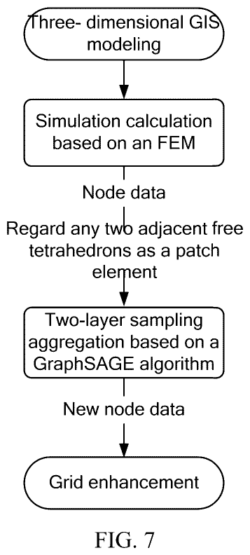

Based on the content disclosed in Embodiment 1, as shown in FIG. 7, a process in which the simulator implements simulation enhancement of an electromagnetic field distribution of the GIS using an FETD method in Embodiment 1 is described in detail. The simulator includes:
a simulation module configured to take the coarse positioning result that is of the partial discharge source and obtained based on the full time-domain waveform diagram as an initial injection point of a three-dimensional simulation model of the GIS to simulate a partial discharge phenomenon of the GIS, and perform simulation calculation to obtain a coarse-grid simulation result; and
an enhancement module configured to enhance the coarse-grid simulation result by using an enhancement model, and obtain the simulation enhancement data.

The simulation module is specifically configured to take the coarse positioning result that is of the partial discharge source and obtained based on the full time-domain waveform diagram as the initial injection point of the three-dimensional simulation model of the GIS to simulate the partial discharge phenomenon of the GIS, and perform the simulation calculation by using the FETD method to obtain the coarse-grid simulation result. Specifically, based on structural parameters of the GIS, the three-dimensional simulation model can be established by using simulation software such as COMSOL Multiphysics, and the three-dimensional simulation model can be discretized into a plurality of tetrahedral elements by a finite element method (FEM). Each of the tetrahedral elements includes a plurality of nodes, and the simulation calculation is performed to obtain coarse-grid simulation data that needs to be processed.

The enhancement module is specifically configured to perform simulation enhancement on the coarse-grid simulation data based on a GraphSAGE algorithm, and includes:
a network abstraction unit configured to abstract the three-dimensional simulation model of the GIS into network topology G=(Vₚ, Eₛ), and regard any two adjacent free tetrahedrons in the network topology as a patch element, where Vₚ represents a node set, Eₛ represents an edge set, and a connection line between grid vertices is taken as an edge;
a primary aggregation unit configured to take simulation feature data of a node as an initial benchmark feature, and perform primary aggregation on a neighbor node of each node in each patch element by using the GraphSAGE algorithm to generate an initial benchmark feature of a new node; and
a secondary aggregation unit configured to perform secondary aggregation on a neighbor node of the new node by using the GraphSAGE algorithm to generate a feature vector representation of the new node.

It should be noted that for a new node generated by a coincident face of any two adjacent free tetrahedrons, each node in a patch element composed of these two free tetrahedrons can be used as a neighbor node of the new node. The GraphSAGE algorithm is used to perform the secondary aggregation on the neighbor node of the new node to generate the feature vector representation of the new node, that is, three-dimensional spatial coordinate data and electric field strength of the new node are obtained. Thus, more new node data is generated on a basis of original grid node data, thereby enhancing and refining grid node data generated by the simulation calculation.

In detail, in the GraphSAGE algorithm, a neighbor node is usually randomly sampled to update a representation of a target node. However, in GIS simulation, selection of the neighbor node needs to consider more factors, such as a physical distance and a similarity between the nodes. Therefore, in this embodiment, two free tetrahedral elements are regarded as one patch element, such that neighbors of the new node are gathered in one patch element, achieving a higher similarity and correlation between the nodes. In addition, considering that there are a plurality of types of node features in GIS simulation data, taking spatial coordinates and electric field strength of a node as node features is more in line with data connection of the GIS simulation. Moreover, according to the complexity and scale of the GIS simulation data, this embodiment adjusts a model depth of the GraphSAGE algorithm, namely a quantity of aggregation layers, and improves an expression capability of the algorithm for the data to obtain better performance.

As a further preferred technical solution, the primary aggregation unit is configured to perform the following steps:

(1) Simulation feature data of each node is taken as an initial benchmark feature of each node.

(2) Each node i in each patch element is traversed, all adjacent nodes of each node are taken as sampling points to obtain neighbor set [symbol] (i) of the node i, and initial benchmark features of all nodes in the neighbor set corresponding to the node i are aggregated by using an aggregation function to obtain primarily-aggregated neighbor feature

$${h}_{𝒩 ( i )}^{1} .$$

Specifically, a feature vector of each node v (∀v∈Vₚ) in the network topology, namely the simulation feature data, is taken as benchmark feature

$${h}_{υ}^{0}$$

corresponding to each node. For each patch element, each node i(∀i∈{A, B, C, D, E}) in the patch element is traversed in the primary aggregation. For the node i, its neighbor set [symbol] (i) is first obtained, and a feature vector of the node i is taken as its initial benchmark feature

$${h}_{i}^{0} .$$

Specifically, the initial benchmark features of all the nodes in the neighbor set corresponding to the node i are aggregated through an aggregator by using the aggregation function to obtain the primarily-aggregated neighbor feature

$${h}_{𝒩 ( i )}^{1} ,$$

which is expressed as follows:

$${h}_{𝒩 ( i )}^{1} = {AGGREGATE}_{1} ( \{ {h}_{i}^{0} , ∀ i ∈ 𝒩 ( i ) \} )$$

In the above formula, AGGREGATE₁( ) represents the aggregation function.

(3) The initial benchmark feature and the aggregated neighbor feature

$${h}_{𝒩 ( i )}^{1}$$

are concatenated to obtain a first joint feature, a matrix multiplication operation is performed on a first weight matrix and the first joint feature, and then nonlinear transformation is performed to obtain primarily-traversed node feature

$${h}_{i}^{1} .$$

Specifically, in this embodiment, the primarily-traversed feature

$${h}_{i}^{1}$$

of each node is taken as a new feature vector representation of the node and as a benchmark feature of each node in a secondary traversal process, where:

$${h}_{i}^{1} = σ ( {W}^{1} \cdot CONCAT ( {h}_{i}^{0} , {h}_{𝒩 ( i )}^{1} ) )$$

In the above formula, CONCAT represents a concatenation function, W¹ represents the first weight matrix, and σ represents is a sigmoid function.

Further, in this embodiment, a mean aggregation function MEAN AGGREGATE is used as the aggregation function, namely

$${h}_{i}^{1} = σ ( {W}^{1} \cdot MEAN ( \{ {h}_{i}^{0} \} ⋃ \{ {h}_{i}^{0} , ∀ i ∈ N ( i ) \} ) ) .$$

(4) Initial benchmark features of a common node of the two free tetrahedrons in each patch element are aggregated by using the aggregation function, and the initial benchmark feature of the new node is obtained.

Specifically, since the new node generated by the coincident face of the two adjacent free tetrahedrons has no initial benchmark feature, in this embodiment, the initial benchmark feature

$${h}_{p}^{1}$$

of the new node P is obtained by aggregating the initial benchmark features of the common node of the two adjacent free tetrahedrons by using the aggregation function, which is expressed by the following formula:

$${h}_{p}^{1} = {AGGREGATE}_{1} ( {h}_{B}^{0} , {h}_{C}^{0} , {h}_{D}^{0} )$$

In the above formula,

$${h}_{B}^{0} , {h}_{C}^{0} , {h}_{D}^{0}$$

represents the initial benchmark features of the common node of the two adjacent free tetrahedrons.

Further, in this embodiment, the mean aggregation function is used as the aggregation function. Therefore,

$${h}_{p}^{1} = MEAN ( {h}_{B}^{0} , {h}_{C}^{0} , {h}_{D}^{0} ) .$$

As a further preferred technical solution, the secondary aggregation unit is configured to perform the following steps:

(1) The primarily-traversed node feature

$${h}_{i}^{1}$$

is taken as a new benchmark feature of the corresponding node.

(2) Each node i in each patch element is taken as a neighbor sampling point of the new node, and new benchmark features of all nodes in each patch element are aggregated by using an aggregation function to obtain secondarily-aggregated neighbor feature

$${h}_{P ( i )}^{2} .$$

Specifically, in this embodiment, all the nodes i in the patch element are taken as neighbor set P(i) of the new node generated by the patch element. New benchmark features of all nodes in the neighbor set, namely

$${h}_{i}^{1} ( ∀ i ∈ \{ A , B , C , D , E \} ) ,$$

are aggregated through a second aggregator by using the aggregation function to obtain the secondarily-aggregated neighbor feature

$${h}_{P ( i )}^{2} ,$$

which is expressed by the following formula:

$${h}_{P ( i )}^{2} = {AGGREGATE}_{2} ( {h}_{A}^{1} , {h}_{B}^{1} , {h}_{C}^{1} , {h}_{D}^{1} , {h}_{E}^{1} )$$

In the above formula, AGGREGATE₂( ) represents the aggregation function, and

$${h}_{A}^{1} , {h}_{B}^{1} , {h}_{C}^{1} , {h}_{D}^{1} , {h}_{E}^{1}$$

represents a new benchmark feature of each node in the patch element.

(3) The initial benchmark feature of the new node and the secondarily-aggregated neighbor feature are concatenated to obtain a second joint feature, the matrix multiplication operation is performed on a second weight matrix and the second joint feature, and then the nonlinear transformation is performed to obtain the feature vector representation of the new node.

Specifically, in this embodiment, the obtained feature vector representation of the new node is as follows:

$${h}_{P}^{2} = σ ( {W}^{2} \cdot CONCAT ( {h}_{p}^{1} , {h}_{P ( i )}^{2} ) )$$

In the above formula, CONCAT represents the concatenation function, W² represents the second weight matrix, and σ represents is the sigmoid function.

Further, since neighbors of a node have no natural order, and the aggregator AGGREGATEₖ in this embodiment uses the mean aggregation function,

$${h}_{p}^{2} = σ ( {W}^{2} \cdot MEAN ( \{ {h}_{p}^{1} \} ⋃ \{ {h}_{A}^{1} , {h}_{B}^{1} , {h}_{C}^{1} , {h}_{D}^{1} , {h}_{E}^{1} \} ) ) .$$

Therefore, a feature vector of a new node, namely three-dimensional spatial coordinates and electric field strength of the new node, is generated between nodes in any patch element, thereby enhancing grid node data in FEM-based GIS simulation.

As a further preferred technical solution, complexity of the GraphSAGE algorithm adopted in this embodiment is as follows:

$$O ( {\prod }_{i = 1}^{K} {S}_{n} ) , {S}_{n} , n ∈ \{ 1 , … , K \}$$

As described above, K represents a quantity of aggregators, a quantity of weight matrices, and a quantity of network layers. This embodiment uses K aggregators AGGREGATEₖ, ∇k ∈ {1, . . . , K} to aggregate node neighbor information, and uses K weight matrices W^{k}, vk E {1, . . . , K} to propagate information between different layers. To achieve a better sampling and aggregation effect, K=2, that is, two aggregation operations are performed.

As a further preferred technical solution, node sampling in this embodiment is performed based on a fixed length, where Sn represents a quantity of sampled neighbors in an n^{th} layer. Based on a predefined quantity of sampled neighbors, namely S, repeated sampling with replacement or negative sampling is performed to ensure stable complexity. When the predefined quantity of sampled neighbors is greater than an actual quantity of neighbors, the repeated sampling is performed to supplement the actual quantity of sampled neighbors to the S. When the predefined quantity of sampled neighbors is less than the actual quantity of neighbors, the negative sampling is performed to reduce the actual quantity of sampled neighbors to the S.

### Embodiment 4

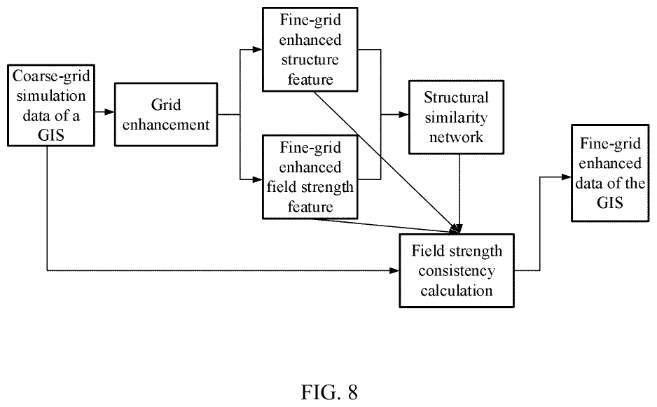

Based on the content disclosed in Embodiment 1, this embodiment specifically adopts a differential deep learning network model to enhance a coarse-grid simulation result to obtain the simulation enhancement data. A specific working principle of the differential deep learning network model is shown in FIG. 8. The differential deep learning network model includes an enhancement network and a structural similarity network that are connected in sequence. The enhancement network includes a self-adjustment module and a differential convolution module, and the coarse-grid simulation result includes coarse-grid structure data and coarse-grid field strength data. The self-adjustment module and the differential convolution module are used to respectively calculate the coarse-grid structure data and the coarse-grid field strength data to obtain a fine-grid enhanced grid structure feature and a fine-grid enhanced field strength feature. The structural similarity network is used to match the fine-grid enhanced grid structure feature and the fine-grid enhanced field strength feature to calculate a similarity feature. The simulation enhancement data is calculated based on the similarity feature.

This embodiment designs and constructs the differential deep learning network model. In the differential deep learning network model, convolution combined with a differential algorithm is adopted to process the coarse-grid field strength data, which can accurately simulate an electromagnetic field distribution of the GIS, especially in a case of dealing with complex geometric structures and boundary conditions. In addition, a deep learning network is used to optimize a simulation process, improve simulation accuracy, and accelerate the simulation process, thereby effectively shortening design and evaluation cycles, and balancing accuracy and efficiency of electromagnetic simulation of the GIS.

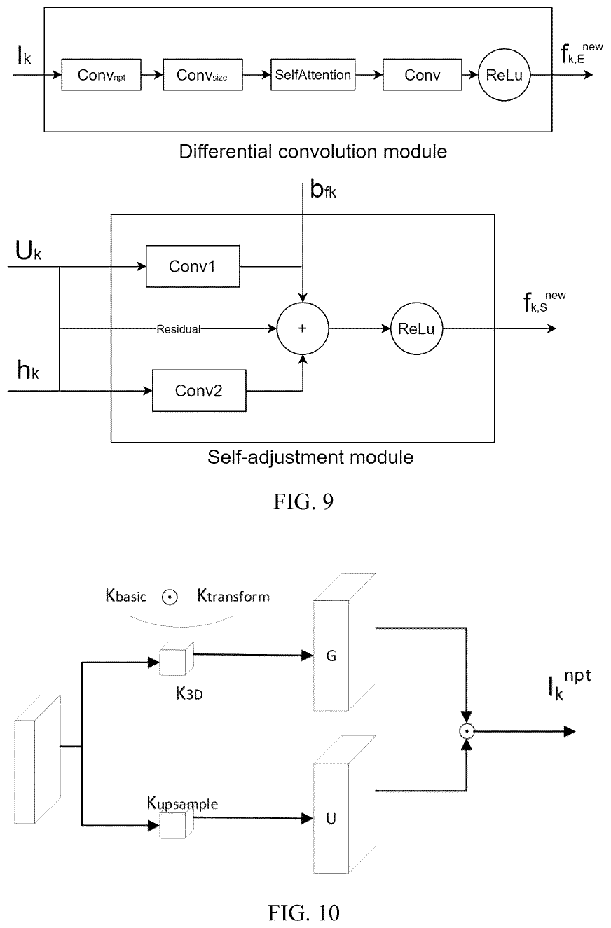

As a further preferred technical solution, as shown in FIG. 9, the self-adjustment module includes first convolutional layer Conv1 and second convolutional layer Conv2 that are connected in sequence, and an output of the first convolutional layer Conv1 and an output of the second convolutional layer Conv2 are output to an activation function layer after a first addition operation.

The coarse-grid structure data is used as an input of the first convolutional layer Conv1, supplementary grid size information of the coarse-grid structure data is used as an input of the second convolutional layer Conv2, a bias vector of the coarse-grid structure data is used as an input of the first addition operation, and the coarse-grid structure data and the supplementary grid size information of the coarse-grid structure data are output to the first addition operation through residual connection Residual.

It should be noted that in this implementation, the self-adjustment module is designed to achieve fine enhancement of the coarse-grid structure data. The self-adjustment module combines a convolution operation, the residual connection, and a sigmoid activation function to achieve fine enhancement of coarse-grid data of an electromagnetic field of the GIS. This method not only improves a detail expression capability of grid data, but also can adaptively adjust an enhancement strategy based on original grid data through a self-adjustment mechanism, thereby ensuring accuracy and adaptability of an enhanced grid structure.

As a further preferred technical solution, the self-adjustment module is configured to perform the fine enhancement on a grid structure. In this embodiment, a k^{th} piece of coarse-grid data Uₖ of the electromagnetic field of the GIS is input into the self-adjustment module of an enhancement module to obtain the fine-grid enhanced grid structure feature

$${f}_{k , S}^{new} ,$$

which is expressed by the following formula:

$${f}_{k , S}^{new} = sigmoid ( Conv 1 ( {U}_{k} ) + Conv 2 ( {h}_{k} ) + {b}_{{f}_{k}} + Residual ( {U}_{k} , {h}_{k} ) )$$

In the above formula,

$${f}_{k , S}^{new}$$

represents the fine-grid enhanced grid structure feature, Conv1 ( ) represents a grid enhancement convolution operation, Conv2 ( ) represents a fine-tuning convolution operation, Uₖ represents the coarse-grid structure data, hₖ represents the supplementary grid size information of the coarse-grid structure data, b_{fx} represents the bias vector of the coarse-grid structure data, Residual ( ) represents the residual connection, and sigmoid represents the activation function.

As a further preferred technical solution, as shown in FIG. 9, the differential convolution module includes differential convolutional layer Convₙₚₜ, size integration layer Conv_{size}, self-attention mechanism layer SelfAttention, and third convolutional layer Conv3 that are connected in sequence, and an ReLU activation function is connected after the third convolutional layer Conv3.

The coarse-grid field strength data is used as an input of the differential convolutional layer Convₙₚₜ, and the differential convolutional layer Convₙₚₜ is configured to calculate field strength features of different sizes of the coarse-grid field strength data by using the differential algorithm.

The size integration layer Conv_{size} is configured to sum the field strength features of different sizes calculated by the differential convolutional layer, and obtain a reorganized field strength feature.

The reorganized field strength feature is processed by the self-attention mechanism layer SelfAttention and the third convolutional layer Conv3 to output the fine-grid enhanced field strength feature.

It should be noted that, in this embodiment, the differential convolution module is designed to precisely extract field strength data. The differential convolution module can accurately extract a strength feature of the electromagnetic field through a specially designed differential convolution operation, thereby effectively simulate a physical distribution of the electromagnetic field. Moreover, by combining the self-attention mechanism, the differential convolution module can highlight an important field strength feature, thereby improving extraction accuracy of the field strength data and attention concentration of the model. In addition, multi-scale features of electromagnetic field data can be captured by performing feature extraction and summation by different-sized convolution kernels, which is particularly important for understanding and simulating a complex change in the electromagnetic field. This method enhances a generalization capability of the model, enabling the model to better adapt to electromagnetic field changes of different scales.

As a further preferred technical solution, a convolution kernel of the differential convolutional layer adopts any one of a five-point differential convolution kernel, a weighted differential convolution kernel, a multi-scale differential convolution kernel, a directional differential convolution kernel, a nine-point differential convolution kernel, and a hybrid differential convolution kernel.

It should be noted that those skilled in the art can also select other differential algorithms to combine with the deep learning network based on an actual application requirement, which is not specifically limited in this embodiment.

Further, taking the five-point differential convolution kernel as an example, as shown in FIG. 10, the differential convolutional layer Convₙₚₜ is designed as follows:

Basic convolution kernel K_{basic} is designed based on a five-point differential algorithm:

$${K}_{basic} = \frac{1}{Δ {x}^{2}} [ \begin{matrix}0 & 1 & 0 \\ 1 & - 4 & 1 \\ 0 & 1 & 0\end{matrix} ]$$

Considering data enhancement for three-dimensional electromagnetic field simulation of the GIS, three-dimensional differential convolution kernel K_{3D} is obtained through dimension transformation kernel K_{transform}

$${K}_{transform} = [ \begin{matrix}[ 0 & 0 & 0 ] \\ [ 1 & 0 & - 1 ] \\ [ 0 & 0 & 0 ]\end{matrix} ]$$

$${K}_{3 D} = {K}_{basic} ⊙ {K}_{transform}$$

As described above, represents that corresponding elements are multiplied together.

Gradient information of coarse-grid field strength is extracted by using the three-dimensional differential convolution kernel K_{3D} (a gradient change in a coarse-grid electromagnetic field is extracted to guide generation of fine-grid data):

$$G = {I}_{k} * {K}_{3 D}$$

As described above, * represents the convolution operation, and G represents gradient information data obtained after the K_{3D} is applied.

The coarse-grid field strength data is enhanced through upsampling to obtain upsampled fine-grid field strength data U (refined coarse-grid data):

$$U = {I}_{k} * {K}_{upsample}$$

As described above, Kᵤₚₛₐₘₚₗₑ is obtained as an upsampling convolution kernel is trained with the network.

The gradient information G of the coarse-grid field strength is enhanced to obtain preliminary fine-grid field strength data

$${I}_{k}^{npt} .$$

$${I}_{k}^{npt} = U ⊙ G .$$

In this embodiment, the convolution kernel is defined directly in a form of the differential algorithm, which ensures that a physical principle can be accurately mapped onto the convolution operation. This is achieved by extracting a core calculation formula of the differential algorithm and converting the core calculation formula into a form of the convolution kernel, thereby ensuring correct application of continuous physical laws to discrete data. Moreover, in this embodiment, scale transformation is taken into account when the differential convolution kernel is designed, which allows the electromagnetic field to be analyzed under different resolutions. A size and a shape of the convolution kernel can be adjusted to simulate different physical resolutions, thereby capturing the multi-scale features.

A two-dimensional convolution kernel is extended to a three-dimensional space through certain transformation, that is, a traditional differential method is applied to a key step of the three-dimensional electromagnetic field simulation of the GIS. This dimension transformation takes into account a physical effect in each direction of the three-dimensional space. Symmetrical three-dimensional convolution kernels can be designed to solve a problem of rotational invariance. A symmetrical kernel will produce consistent responses in all directions, which can address an isotropic problem in the electromagnetic field simulation.

It should be noted that the specially designed differential convolution operation in this embodiment is a method for solving a partial differential equation based on a numerical value, such as a five-point differential method. This method is commonly used in numerical analysis to approximate a solution of the partial differential equation. In deep learning, a traditional convolution is typically used to extract a feature of input data, while a special differential convolution kernel can be designed to better adapt to simulation of a specific physical phenomenon, such as the electromagnetic field simulation. This special differential convolution kernel is usually designed based on discrete approximation of a second-order derivative of a function space in the differential algorithm, thereby enabling the network to capture physical characteristics of data while learning the data.

Compared with the traditional convolution, differential convolution can maintain high-quality data and ensure that the data conforms to specific physical laws, making data generated by the network more physically reliable. Moreover, this combination approach enables the model to perform even better when dealing with problems that require precise physical modeling, such as the electromagnetic field simulation and climate change simulation.

Further, a function of the differential convolution module disposed in this embodiment is to obtain precise fine-grid field strength data. The differential convolution module is used to process a k^{th} piece of coarse-grid field strength data Iₖ of the electromagnetic field of the GIS, thereby obtaining the fine-grid enhanced field strength feature

$${f}_{k , E}^{new} ,$$

when Is tapicosuu uy un following formula:

$${I}_{k}^{npt} = {Conv}_{npt} ( {I}_{k} )$$

$${I}_{k}^{Con} = {Conv}_{size} ( {I}_{k}^{npt} )$$

$${f}_{k , E}^{new} = ReLU ( Conv ( SelfAttention ( {I}_{k}^{Con} ) ) )$$

In the above formula,

$${I}_{k}^{npt}$$

represents a field strength feature generated by the difference convolution, Convₙₚₜ ( ) represents the differential convolution operation, Iₖ represents the coarse-grid field strength data,

$${I}_{k}^{C o n}$$

represents the reorganized field strength feature, Conv_{size} represents application of the different-sized convolution kernels,

$${f}_{k , E}^{n e w}$$

iron in the hand field strength feature, SelfAttention ( ) represents an operation of the self-attention mechanism, Conv ( ) represents the convolution operation, and ReLU represents the activation function.

Further, in this embodiment, the self-adjustment module and the differential convolution module are combined, thereby optimizing calculation efficiency and accuracy of the simulation. The self-adjustment module reduces unnecessary calculation through an intelligent enhancement strategy, while the differential convolution module ensures high-precision extraction of the field strength data. The self-adjustment module and the differential convolution module work together to achieve efficient and accurate electromagnetic field simulation. Overall, the design and implementation of the self-adjustment module and the differential convolution module have significantly enhanced accuracy, efficiency, and applicability of the electromagnetic field simulation of the GIS through intelligent enhancement, precise feature extraction, and efficient calculation methods.

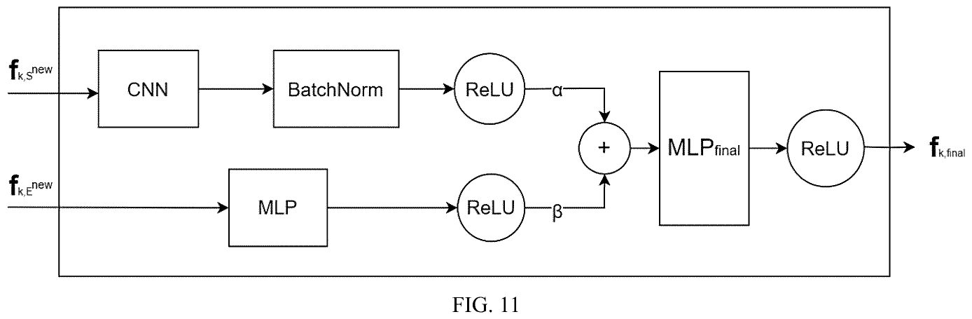

As a further preferred technical solution, as shown in FIG. 11, the structural similarity network includes a first branch network, a second branch network, a second addition operation, and a first MLP, outputs of the first branch network and the second branch network are both connected to the second addition operation, an output of the second addition operation is connected to the first MLP MLP_{final}, and activation function ReLU is connected after the first MLP MLP_{final}.

Specifically, the first branch network includes a CNN layer and batch normalization operation BatchNorm that are connected in sequence, and activation function ReLU is connected after the batch normalization operation BatchNorm.

The second branch network includes second MLP MLP, and activation function ReLU is connected after the second MLP MLP.

Further, a function of the structural similarity network is to match enhanced grid data and field strength data, and obtain a combined field strength and structure feature based on fine-grid enhanced grid structure feature

$${f}_{k , S}^{new}$$

and fine-grid enhanced field strength feature

$${f}_{k , E}^{new}$$

of the k^{th} piece of coarse-grid data of the electromagnetic field of the GIS:

$${f}_{k , S}^{CNN} = ReLU ( BatchNorm ( CNN ( {f}_{k , S}^{new} ) ) )$$

$${f}_{k , E}^{MLP} = ReLU ( MLP ( {f}_{k , E}^{new} ) )$$

$${f}_{k , combined} = α \cdot {f}_{k , S}^{CNN} + β \cdot {f}_{k , E}^{MLP}$$

$${f}_{k , final} = ReLU ( {MLP}_{final} ( {f}_{k , combined} )$$

In the above formulas,

$${f}_{k , S}^{CNN}$$

represents extracted information of the fine-grid enhanced grid structure feature corresponding to the k^{th} piece of coarse-grid data of the electromagnetic field of the GIS;

$${f}_{k , E}^{MLP}$$

represents extracted information of the fine-grid enhanced field strength feature corresponding to the k^{th} piece of coarse-grid data of the electromagnetic field of the GIS; α and β respectively represent modulation weights of the extracted information

$${f}_{k , S}^{CNN}$$

of the fine-grid enhanced grid structure feature and the extracted information

$${f}_{k , E}^{MLP}$$

of the fine-grid enhanced field strength feature; f_{k,combined} represents a comprehensive feature of the extracted information of the fine-grid enhanced grid structure feature and the extracted information of the fine-grid enhanced field strength feature; f_{k,final} represents the similarity feature; BatchNorm ( ) represents the batch normalization operation; CNN ( ) represents the convolution operation; MLP_{final} ( ) represents an MLP of the structural similarity module; and f_{k,combined} represents the combined field strength and structure feature.

It should be noted that the function of the structural similarity network designed in this embodiment is as follows: (1) Retaining a physical structure: The structural similarity module focuses on a structural attribute of the data to ensure that the enhanced data retains its physical accuracy and maintains structural integrity and coherence. This is particularly important in the simulation field, as a physical behavior of the electromagnetic field is highly dependent on spatial structural characteristics of the electromagnetic field. (2) Enhancing data enhancement quality: This module is designed to generate higher-quality data, especially in restoration and super-resolution tasks, thereby ensuring that details of the generated data have a high structural similarity to original coarse-grid data. (3) Enhancing a feature representation: By integrating features extracted by the CNN and the MLP, the structural similarity module provides an effective mechanism to enhance and significantly represent key features in the electromagnetic field data, especially in terms of the field strength and the grid structure.

As a further preferred technical solution, fine-grid enhanced data of the GIS is calculated based on the similarity feature, which specifically includes the following steps:

(1) Regularized coarse-grid structure data, regularized coarse-grid field strength data, a regularized fine-grid enhanced grid structure feature, and a regularized fine-grid enhanced field strength feature are respectively calculated based on the coarse-grid structure data, the coarse-grid field strength data, the fine-grid enhanced grid structure feature, and the fine-grid enhanced field strength feature.

It should be noted that, in this embodiment, the field strength consistency module is specifically disposed to process the coarse-grid structure data, the coarse-grid field strength data, the fine-grid enhanced grid structure feature, the fine-grid enhanced field strength feature, and the similarity feature to converge a difference between the fine-grid enhanced data and the coarse-grid data.

The following formulas are used to calculate the fine-grid enhanced data

$$( {f}_{k , S}^{C} , {f}_{k , E}^{C} )$$

after comprehensive compensation is performed on the k^{th} piece of fine-grid enhanced grid structure feature

$${f}_{k , S}^{new}$$

and fine-grid enhanced field strength feature

$${f}_{k , S}^{n e w}$$

of the electromagnetic field of the GIS and the k^{th} piece of coarse-grid data Uₖ and coarse-grid field strength data Iₖ of the electromagnetic field of the GIS:

$${f}_{k , S}^{norm} = \frac{{f}_{k , S}^{n e w}}{{‖ {f}_{k , S}^{n e w} ‖}_{2}}$$

$${f}_{k , E}^{norm} = \frac{{f}_{k , E}^{n e w}}{{‖ {f}_{k , E}^{n e w} ‖}_{2}}$$

$${U}_{k}^{norm} = \frac{{U}_{k}}{{‖ {U}_{k} ‖}_{2}}$$

$${I}_{k}^{norm} = \frac{{I}_{k}}{{‖ {I}_{k} ‖}_{2}}$$

In the above formulas,

$${f}_{k , S}^{norm} , {f}_{k , E}^{norm} , {U}_{k}^{norm} , and {I}_{k}^{norm}$$

respectively represent the regularized fine-grid enhanced grid structure feature of the electromagnetic field, the regularized fine-grid enhanced field strength feature, the regularized coarse-grid data of the electromagnetic field, and the regularized coarse-grid field strength data; and ∥·I|₂ represents a matrix 2-norm.

(2) Grid structure consistency is calculated based on the regularized coarse-grid structure data and the regularized fine-grid enhanced grid structure feature.

Specifically, a calculation formula of the grid structure consistency is as follows:

$${D}_{S} = \sqrt{\sum {( {f}_{k , S}^{norm} - {U}_{k}^{norm} )}^{2}}$$

In the above formula, Dₛ represents the grid structure consistency.

(3) Grid field strength consistency is calculated based on the regularized coarse-grid field strength data and the regularized fine-grid enhanced field strength feature.

Specifically, a calculation formula of the grid field strength consistency is as follows:

$${D}_{E} = \sqrt{\sum {( {f}_{k , E}^{norm} - {I}_{k}^{norm} )}^{2}}$$

In the above formula, D_{E} represents the grid field strength consistency.

(4) A compensation for a grid field strength loss is calculated based on the grid structure consistency and the grid field strength consistency.

Specifically, a calculation formula of the compensation for the grid field strength loss is as follows:

$${C}_{k} = λ \cdot {D}_{S} + ( 1 - λ ) \cdot {D}_{E}$$

In the above formula, Cₖ represents the compensation for the grid field strength loss.

(5) Fine-grid enhanced structure data is calculated based on the fine-grid enhanced grid structure feature, the compensation for the grid field strength loss, and the similarity feature.

Specifically, a calculation formula of the fine-grid enhanced structure data is as follows:

$${f}_{k , S}^{C} = {f}_{k , S}^{n e w} - γ \cdot {C}_{k} + {f}_{k , final}$$

In the above formula,

$${f}_{k , S}^{C}$$

represents the fine-grid enhanced structure data.

(6) Fine-grid enhanced field strength data is calculated based on the fine-grid enhanced field strength feature, the compensation for the grid field strength loss, and the similarity feature.

Specifically, a calculation formula of the fine-grid enhanced field strength data is as follows:

$${f}_{k , E}^{C} = {f}_{k , E}^{n e w} - γ \cdot {C}_{k} + {f}_{k , final}$$

In the above formula,

$${f}_{k , E}^{C}$$

represents the fine-grid chanced field strength data, and λ and γ represent scale factors.

As a further preferred technical solution, the differential deep learning network model used in this embodiment is a pre-trained model that can be used to calculate a similarity between the grid structure and the grid field strength. A training process includes the following steps:

A coarse-grid historical simulation dataset of the electromagnetic field of the GIS is used, and the differential deep learning network model is trained based on the historical simulation dataset until a total loss function of the model reaches a minimum value. Herein, the total loss function includes a constraint loss function based on the Maxwell's equation and a field strength and structure consistency loss function, which is expressed by the following formula:

$${L}_{total} = η {L}_{consistency} + ζ {L}_{Maxwell}$$

In the above formula, Lₜₒₜₐₗ represents the total loss function, L_{consistency} represents field strength and structure consistency loss function, L_{Maxwell} represents the constraint loss function based on the Maxwell's equation, and η and ζ represent weight parameters.

It should be noted that, in this embodiment, a multi-dimensional loss function is designed. By combining a structural similarity loss, a field strength consistency loss, and a physical constraint loss, a plurality of important characteristics of simulation data are comprehensively considered. The design of this multi-dimensional loss function is conducive to ensuring accuracy of the simulation and can also adjust weights of different losses to meet specific simulation requirements and optimization goals.

Further, a formula of the field strength and structure consistency loss function is expressed as follows:

$${L}_{struct} = \sum {‖ {∇}_{n} {f}_{k , S}^{n e w} - {∇}_{n} {U}_{k} ‖}^{2}$$

$${L}_{field} = \sum {( {f}_{k , E}^{n e w} - {I}_{k} )}^{2}$$

$${L}_{consistency} = σ {L}_{struct} + δ {L}_{field}$$

In the above formula, ∇ₙ represents a gradient obtained by applying a differential method, L_{struct} represents the structural similarity loss, L_{field} represents the field strength consistency loss, σ and δ represent scale factors,

$${f}_{k , S}^{n e w}$$

represents the fine-grid enhanced grid structure feature, Uₖ represents the coarse-grid structure data,

$${f}_{k , E}^{n e w}$$

represents the fine-grid enhanced field strength feature, Iₖ represents the coarse-grid field strength data, and ∥ ∥² represents a vector 2-norm.

It should be noted that, in this embodiment, the structural similarity loss and the field strength consistency loss ensure that the enhanced electromagnetic field data is highly consistent with the original data in terms of the structure and the field strength. This consistency not only promotes convergence of the simulation data, but also guarantees physical authenticity of the simulation result, thereby improving reliability of the simulation.

Moreover, the scale factors are introduced to provide a flexible mechanism for adjusting a loss function. This mechanism not only can adjust importance of different parts in the loss function based on a specific task, but also can enhance a generalization capability and adaptability of the model in dealing with different types of electromagnetic field data.

Further, a formula of the constraint loss function based on the Maxwell's equation is expressed as follows:

$${f}_{B}^{C} \approx κ \cdot ( ∇ \times {f}_{k , E}^{C} )$$

$${L}_{Gauss} = {‖ ∇ \cdot {f}_{k , E}^{C} ‖}^{2}$$

$${L}_{Gauss - Mag} = {‖ ∇ \cdot {f}_{B}^{C} ‖}^{2}$$

$${L}_{Faraday} = {‖ ∇ \times {f}_{k , E}^{C} + \frac{\partial {f}_{B}^{C}}{\partial t} ‖}^{2}$$

$${L}_{Ampere} = {‖ ∇ \times {f}_{B}^{C} - {μ}_{0} {ϵ}_{0} \frac{\partial {f}_{k , E}^{C}}{\partial t} ‖}^{2}$$

$${L}_{Maxwell} = {w}_{1} \cdot {L}_{Gauss} + {w}_{2} \cdot {L}_{Gauss - Mag} + {w}_{3} \cdot {L}_{Faraday} + {w}_{4} \cdot {L}_{Ampere}$$

In the above formula,

$${f}_{B}^{C}$$

represents a magnetic field component, L_{Gauss} represents a loss of the Gauss's law, L_{Gauss}-Mag represents a loss of the Gauss's magnetic law, L_{Faraday} represents a loss of the Faraday's law of electromagnetic induction, L_{Ampere} represents a loss of the Ampere's law, κ represents a scale constant, w₁, w₂, w₃, and w₄ represent scale factors, ∇ represents a curl, ∥·∥² represents the vector 2-norm, μ₀ represents permeability of vacuum, ∈o represents permittivity or the vacuum, and

$${f}_{k , E}^{C}$$

represents the fine-grid enhanced field strength data.

It should be noted that based on key components of the Maxwell's equation set, namely the Gauss's law, the Gauss's magnetic law, the Faraday's law of electromagnetic induction, and the Ampere's law, the physical constraint loss function ensures that the enhanced electromagnetic field data strictly follows basic laws of electromagnetism. This constraint makes the electromagnetic field data output by the model not only numerically accurate but also strictly in accordance with the physical laws, thereby enhancing scientificity and practicability of the model.

It should be noted that when the differential method is combined with a generative adversarial network to form a differential-enhanced generative adversarial network, the differential convolution kernel is mainly integrated into a generator architecture, thereby introducing differential enhancement of a spatial feature. The “adversarial” nature herein is mainly reflected in a loss of the model. That is, when the generative adversarial network is adopted, the total loss function of the model includes not only the physical constraint loss function and the field strength and structure consistency loss function, but also an adversarial loss part.

In summary, the loss function designed in this embodiment combines advantages of a traditional physical model and the deep learning. Through a precise mathematical expression and a physical constraint, the loss function helps to optimize stability and a convergence speed of the algorithm and improve training efficiency. By integrating an electromagnetic field theory and a deep learning technology, the total loss function not only enhances a capability of the model in processing electromagnetic field simulation data, but also ensures the accuracy and physical authenticity of the simulation result, providing an effective optimization strategy for the electromagnetic field simulation.

### Embodiment 5

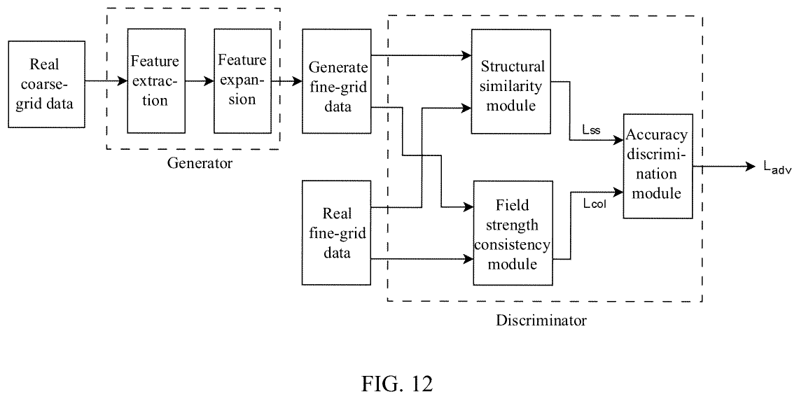

Based on the content disclosed in Embodiment 1, this embodiment specifically adopts a generative adversarial network model to enhance a coarse-grid simulation result, thereby obtaining enhanced fine-grid data. FIG. 12 is a block diagram of a specific implementation principle.

An enhancement model adopts the generative adversarial network model. The generative adversarial network model includes a generator and a discriminator. The generator is configured to perform feature extraction on the coarse-grid simulation result and conduct cyclic multiplicative enhancement on an extracted feature to obtain the enhanced fine-grid data.

The discriminator includes a structural similarity module, a field strength consistency module, and an accuracy discrimination module.

The structural similarity module is configured to calculate a first confidence value of structural information contained in the enhanced fine-grid data and real fine-grid data that is obtained through the simulation.

The field strength consistency module is configured to calculate a second confidence value of field strength information contained in the enhanced fine-grid data and the real fine-grid data that is obtained through the simulation.

The accuracy discrimination module is configured to narrow a distance between a distribution of the enhanced fine-grid data and a distribution of the real fine-grid data that is obtained through the simulation.

It should be noted that, in this embodiment, real coarse-grid data and the real fine-grid data are input into a generative adversarial network in advance for training. When an overall optimization loss function reaches a minimum value, a trained generator is obtained as a data enhancement model for enhancing real coarse-grid data generated in real time. Herein, a generator network is responsible for learning a potential distribution feature of a real sample and performing synthesis to generate a new sample. A discriminator network is used to distinguish between the real sample and the generated new sample. The generator and the discriminator achieve an adversarial effect through alternating training, thereby continuously improving their respective generation and discrimination capabilities. Ultimately, the generator network and the discriminator network reach a Nash equilibrium in their adversarial process.

In this embodiment, the discriminator is designed to determine whether input data meets a requirement. The discriminator consists of the structural similarity module, the field strength consistency module, and the accuracy discrimination module. Discrimination accuracy can be effectively improved by dividing grid data into structure data and field strength data for comparative analysis.

Since the GIS has a specific physical structure, a data point in the electromagnetic field simulation cannot exceed a certain range. In a PU-GAN designed in the embodiments of the present disclosure, multiplicative enhancement is performed on a coarse-grid data point through upsampling. The generator adopts the cyclic multiplicative enhancement to enhance the electromagnetic field between coarse-grid data points. To a certain extent, this ensures that a physical structure scope of the GIS is not exceeded, and improves accuracy of data enhancement in the electromagnetic field simulation of the GIS.

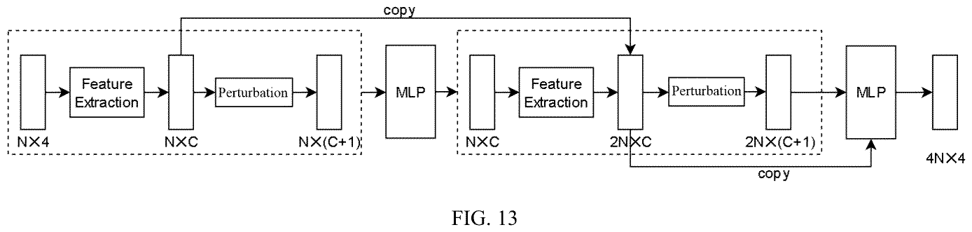

As a further preferred technical solution, as shown in FIG. 13, the generator includes a plurality of cascaded feature extraction and expansion networks, and an MLP is connected after each of the feature extraction and expansion networks.

The feature extraction and expansion network includes a feature extraction module and a feature expansion module that are connected in sequence. An output of the feature extraction module in an upper-level feature extraction and expansion network is connected to an output of the feature extraction module in a lower-level feature extraction and expansion network.

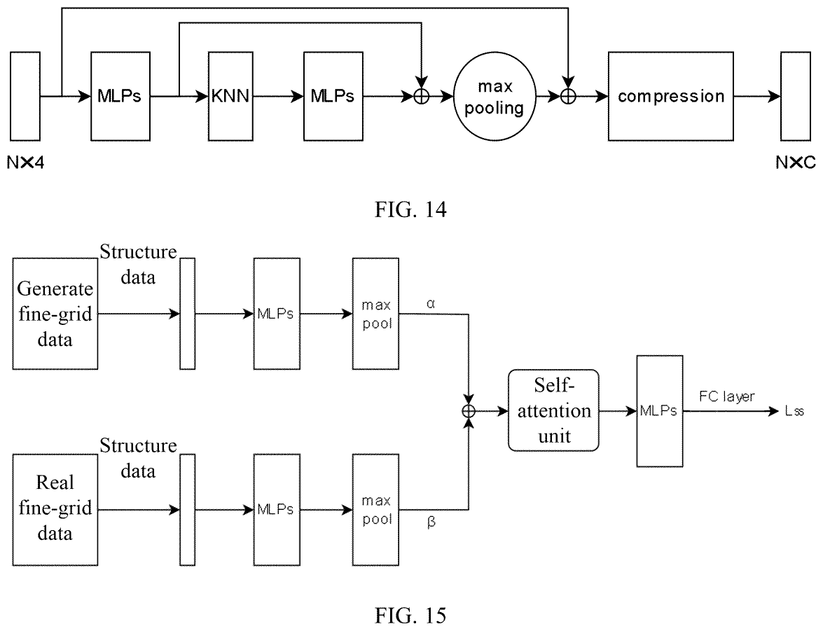

As shown in FIG. 14, the feature extraction module includes a first MLPs layer, a K-nearest neighbor (KNN) layer, a second MLPs layer, a maxpooling layer, and a data compression layer that are connected in sequence. The coarse-grid simulation result is used as an input of the first MLPs layer. An output of the first MLPs layer and an output of the second MLPs layer are concatenated and then output to the maxpooling layer. The coarse-grid simulation result and an output of the maxpooling layer are concatenated and then used as an input of the data compression layer. An output of the data compression layer is connected to the feature expansion module.

The feature expansion module is configured to add a vector encoded as 1 or −1 after each feature output by the feature extraction module to generate location perturbation.

It should be noted that, in this embodiment, the generator is designed to generate required fine-grid data of the GIS based on the enhanced coarse-grid data of the GIS. The generator is designed through the cyclic multiplicative enhancement. In this way, a coarse-grid data enhancement multiple can be independently adjusted based on a requirement, and the multiplicative enhancement can better retain a feature of coarse-grid data.

Specifically, a working process of the feature extraction module in this embodiment is as follows: First, through the first MLPs layer, fixed-scale feature C′ is extracted from N×4-dimensional information composed of three-dimensional spatial coordinates (x, y,z) and field strength value v that are input into each sampling point. Then, the feature is divided into N×K groups through the KNN layer, and a group feature is further optimized through the second MLPs layer to obtain a G-channel feature. The feature output by the second MLPs layer and the feature output by the first MLPs layer are merged to obtain a new G-channel feature (a total of N×K×(2G+C′) features). Finally, group information is condensed through maxpooling to obtain a final N×(2G+C′) feature, and an initial N×4-dimensional feature output for the sampling point is added. This feature is aggregated as a multi-scale feature of the feature extraction module and fed into subsequent modules for reuse, thereby improving reconstruction accuracy, increasing parameter efficiency, and reducing a model size. Under a compression effect of the last data compression layer, an N×C feature is obtained. After the obtained N×C feature is copied, the vector encoded as 1 or −1 is added after each feature to generate the location perturbation, and then a subsequent MLP is used to regress a 2N×(C+1) feature into 2N×4 data.

It should be noted that a 2′N×C feature can be obtained through a plurality of cyclic feature extraction and expansion operations, and is finally regressed to four-dimensional data 2″N×4 by one MLP.

It should be noted that a value of the r depends on a precision difference between an input simulated coarse grid and an input simulated fine grid, which is not specifically limited in this embodiment.

Specifically, different modules have different data precision. If it is necessary to transfer an upper-layer feature to a next layer, a good interpolation technology is required to match features of different levels. In this embodiment, when a feature output by the feature extraction module in the upper-level feature extraction and expansion network is copied to the output of the feature extraction module in the lower-level feature extraction and expansion network, the interpolation technology is adopted to match the features of different levels.

As a further preferred technical solution, this embodiment uses a bilateral interpolation technology, which uses a feature around a target point for interpolation. A feature value output by an upper-level feature extraction module for point pᵢ is interpolated as follows:

$$\tilde{{f}_{i}} = \frac{{\sum }_{{i}^{′} ∈ {N}_{i}^{′}} θ ( {p}_{i} , {p}_{{i}^{′}} ) ψ ( {f}_{i} , {f}_{{i}^{′}} ) {f}_{{i}^{′}}}{{\sum }_{{i}^{′} ∈ {N}_{i}^{′}} θ ( {p}_{i} , {p}_{{i}^{′}} ) ψ ( {f}_{i} , {f}_{{i}^{′}} )}$$

As described above, pᵢ represents coordinates and field strength of an i^{th} point, pᵢ′ represents coordinates and field strength of an i′^{th} point, fᵢ represents a corresponding feature value of the i^{th} point, fᵢ′ represents a corresponding feature value of the i′^{th} point, and

$${N}_{i}^{′}$$

represents a set di data points that need to be inserted. A joint weighting function is expressed as follows:

$$θ ( {p}_{1} , {p}_{2} ) = {e}^{- {( \frac{‖ {p}_{1} - {p}_{2} ‖}{r} )}^{2}}$$

$$ψ ( {f}_{1} , {f}_{2} ) = {e}^{- {( \frac{‖ {f}_{1} - {f}_{2} ‖}{h} )}^{2}}$$

As described above, width parameters r and h represent an average distance from a point to a nearest neighbor, and ∥ ∥ represents a magnitude of a vector.

In this embodiment, coarse-grid data enhancement is performed. Bilateral interpolation is adopted to effectively avoid an overlap between generated grid data and source grid data, thereby avoiding waste.

As a further preferred technical solution, as shown in FIG. 15, the structural similarity module includes a first structural branch network, a second structural branch network, and a first regression network. Enhanced structural information contained in the generated fine-grid data and real structural information contained in the real fine-grid data are respectively used as inputs of the first structural branch network and the second structural branch network. Outputs of the first structural branch network and the second structural branch network are subjected to a matrix multiplication operation to output a structural feature matrix.

The structural feature matrix is used as an input of the first regression network to obtain a first confidence value between the enhanced structural information and the real structural information.

Specifically, as shown in FIG. 15, both the first structural branch network and the second structural branch network include an MLP and a maxpooling layer that are connected in sequence. The outputs of the first structural branch network and the second structural branch network are subjected to the matrix multiplication operation to output the structural feature matrix, which is expressed as follows:

$${W}_{s} = α {F}_{G}^{S} + β {F}_{T}^{S}$$

$${F}_{G}^{S} = max pool ( MLPs ( {f}_{G , i}^{S} ) )$$

$${F}_{T}^{S} = max pool ( MLPs ( {f}_{T , i}^{S} ) )$$

In the above formula, Wₛ represents the structural feature matrix,

$${F}_{G}^{S}$$

represents a structural feature of the generated fine-grid data, F_{T}^{S} represents a structural feature of the real fine-grid data, α and β respectively represent modulation weights of the

$${F}_{G}^{S}$$

and the

$${F}_{T}^{S} ,$$

MLPs( ) represents an operation of the MLP, maxpool ( ) represents a maxpooling operation,

$${f}_{G , i}^{S}$$

represents structural information of an i^{th} point of the generated fine-grid data, and

$${f}_{T , i}^{S}$$

represents structural information of an i^{th} point of the real fine-grid data.

Specifically, as shown in FIG. 15, the first regression network includes a first self-attention unit, an MLP, and a fully connected layer that are connected in sequence. The first self-attention unit is configured to generate a structural attention weight based on the structural feature matrix. The structural attention weight is processed by the MLP and the fully connected layer to output the first confidence value.

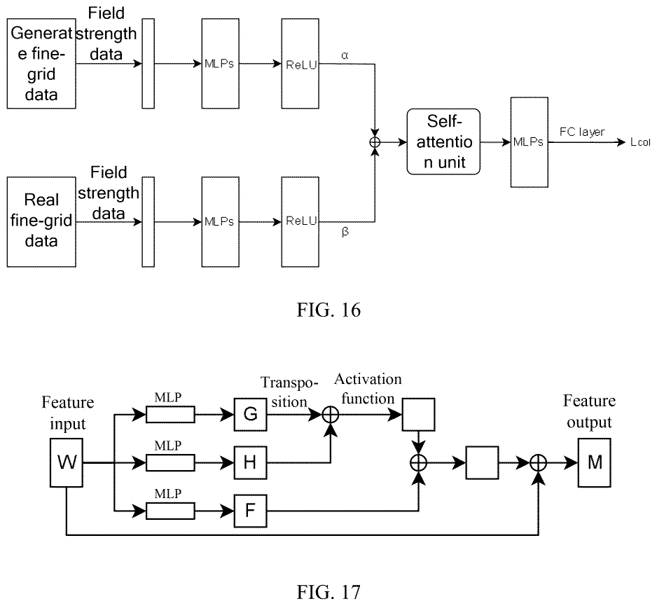

As a further preferred technical solution, as shown in FIG. 16, the field strength consistency module includes a first enhancement branch network, a second enhancement branch network, and a second regression network. Enhanced field strength information contained in the generated fine-grid data and real field strength information contained in the real fine-grid data are respectively used as inputs of the first enhancement branch network and the second enhancement branch network. Outputs of the first enhancement branch network and the second enhancement branch network are subjected to a matrix multiplication operation to output a field strength feature matrix.

The field strength feature matrix is used as an input of the second regression network to obtain a second confidence value between the enhanced field strength information and the real field strength information.

Specifically, both the first enhancement branch network and the second enhancement branch network include an MLP and an activation function that are connected in sequence. The outputs of the first enhancement branch network and the second enhancement branch network are subjected to the matrix multiplication operation to output the field strength feature matrix, which is expressed as follows:

$${W}_{E} = {α}^{′} {F}_{G}^{E} + {β}^{′} {F}_{T}^{E}$$

$${F}_{G}^{E} = ReLU ( MLPs ( {f}_{G , i}^{E} ) )$$

$${F}_{T}^{E} = ReLU ( MLPs ( {f}_{T , i}^{E} ) )$$

In the above formula, W_{E} represents the field strength feature matrix,

$${F}_{G}^{E}$$

represents a field strength feature of the generated fine-grid data,

$${F}_{T}^{E}$$

represents a field strength feature of the real fine-grid data, α′ and β′ respectively represent modulation weights of the

$${F}_{G}^{E}$$

and the

$${F}_{T}^{E} , {f}_{G , i}^{E}$$

represents field strength information of the i^{th} point of the generated fine-grid data, and

$${f}_{T , i}^{E}$$

represents field strength information of the i^{th} point of the real fine-grid data.

Specifically, the second regression network includes a second self-attention unit, an MLP, and a fully connected layer that are connected in sequence. The second self-attention unit is configured to generate a field strength attention weight based on the field strength feature matrix. The field strength attention weight is processed by the MLP and the fully connected layer to output the second confidence value.

As a further preferred technical solution, as shown in FIG. 17, the self-attention unit adopted in this embodiment is used for integrating enhanced features. Specifically, an input feature is converted into G, H, and F through three independent MLPs, and then an attention weight is generated by the G and the H:

$$M = {F ( {f}_{softmax} ( {G}^{T} H ) )}^{T}$$

As described above, f_{softmax} represents a softmax function.

Then, weighted feature M is obtained. Finally, an output feature is generated, which is a sum of the input feature and the weighted feature.

As a further preferred technical solution, in this embodiment, outputs of both the structural similarity module and the field strength consistency module are connected to the accuracy discrimination module. The accuracy discrimination module is configured to control the generated grid structure and field strength data and distinguish accuracy of a generated result. The accuracy discrimination module can be defined as a region-level fully convolutional binary classifier, which can narrow a distance between a distribution of generated fine-grid simulation data and a distribution of fine-grid simulation data obtained by a numerical method. Meanwhile, a least squares adversarial loss is used to ensure stability of the training process.

An adversarial loss between the generated fine-grid data and the real fine-grid data is defined as the following formula:

$${L}_{gan} = {( D ( {f}_{real} ) - 1 )}^{2} + {( D ( {f}_{enh} ) )}^{2}$$

In the above formula, D(Iᵣₑₐₗ) and D(lₑₙₕ) respectively represent confidence values predicted by the discriminator D from the generated fine-grid data fₑₙₕ output by the generator and the real fine-grid data fᵣₑₐₗ.

As a further preferred technical solution, a formula of the overall optimization loss function is expressed as follows:

$${L}_{adv} = {λ}_{1} {L}_{ss} + {λ}_{2} {L}_{col} + {L}_{gan}$$

In the above formula, L_{adv} represents the overall optimization loss function, Lₛₛ represents the first confidence value of the structural information contained in the generated fine-grid data and the real fine-grid data, L_{col} represents the second confidence value of the field strength information contained in the generated fine-grid data and the real fine-grid data, L_{gan} represents the adversarial loss between the generated fine-grid data and the real fine-grid data, and λ₁ and λ₂ represent weight parameters.

The overall optimization loss function set in this embodiment comprehensively considers the structural and field strength confidence of the generated fine-grid data and the real fine-grid data, and has the following advantages: (1) Promoting the generator to generate realistic data: Through an optimization loss function, the generator is forced to generate a sample as close as possible to a distribution of real data. (2) Improving accuracy of the discriminator: The discriminator improves its capability to distinguish between the real data and the generated data through the optimization loss function. That is, the discriminator can be enabled to more accurately identify the data generated by the generator and better distinguish between the generated data and the real data. (3) Achieving a balance between the generator and the discriminator: The optimization loss function ensures a balanced state between the generator and the discriminator, thereby avoiding unstable training due to over-optimization of one of them. This balance helps the generator generate more realistic data, while ensuring that the discriminator can effectively distinguish between the real data and the generated data.

### Embodiment 6

Based on the content disclosed in Embodiment 1, this embodiment describes a specific implementation of the location searcher in Embodiment 1 as follows: The simulation enhancement data includes an enhanced discharge location and an enhanced discharge intensity. The location searcher includes:
a state transition model construction module configured to reconstruct an ant colony algorithm by using a Markov decision model based on an enhanced discharge location and an enhanced discharge intensity at each time point to construct a state transition model corresponding to a process of exploring the actual discharge location of the partial discharge source by taking the coarse positioning result of the partial discharge source as a center;
a heuristic space parameterization module configured to generate a heuristic metric by using a GNN-based heuristic learner, and convert the state transition model into a location exploration model that is affected by the heuristic metric and requires graph traversal; and
an iterative search module configured to perform iterative search on the location exploration model by using a neural-guided perturbation-interleaved local search algorithm, and obtain the actual discharge location of the partial discharge source.

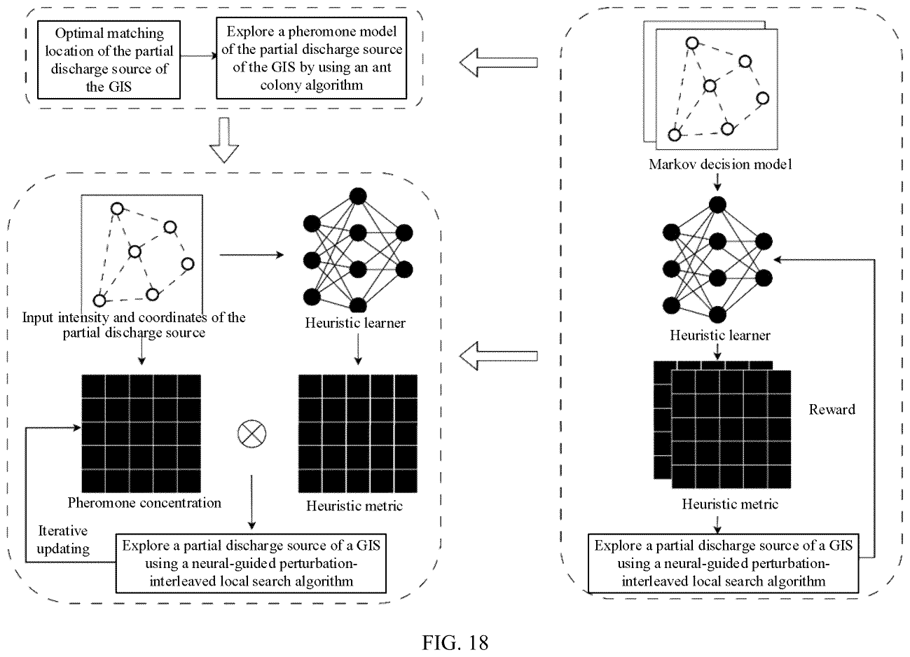

As shown in FIG. 18, in this embodiment, a heuristic rule in the ant colony algorithm is automatically designed and enhanced through a data-driven approach to more effectively achieve rapid iterative search for an optimal matching location of a discharge source. A deep ant colony algorithm uses the GNN to generate the heuristic metric to reduce a demand for expert knowledge, and combines probabilistic local search to achieve better performance and ensure efficient solving.

As a further preferred technical solution, the state transition model construction module is specifically configured to:
construct, based on a simulated discharge location and a simulated discharge intensity at each time point, corresponding state space [symbol] in the process of exploring the actual discharge location of the partial discharge source in the simulator:

$$𝕊 = [ {𝕤}_{1} , … , {𝕤}_{t} , … , {𝕤}_{T} ]$$

$${𝕤}_{t} = [ {p}_{t} , {E}_{t} ]$$

where [symbol] ₜ represents a corresponding state when partial discharge source node i is explored at a t^{th} time point in the simulator, pₜ represents a simulated discharge location at the t^{th} time point, Eₜ represents a simulated discharge intensity at the t^{th} time point, s₁=[P,E] represents an operation of taking initial discharge intensity E and initial discharge location P that are of the partial discharge source and obtained based on the full time-domain waveform diagram of the partial discharge in the GIS as an initial state, T represents an exploration cycle, and t=1, 2, . . . , T;
construct corresponding action space [symbol] in the process of exploring the actual discharge location of the partial discharge source in the simulator:

$$𝔸 = [ {𝕒}_{1} , … , {𝕒}_{t} , … , {𝕒}_{T} ]$$

where [symbol] ₜ represents an action at the t^{th} time point, and the action [symbol] ₜ is selected based on a ε-greedy strategy; and
reconstruct the ant colony algorithm to construct the state transition model corresponding to the process of exploring the actual discharge location of the partial discharge source by taking the initial discharge location of the partial discharge source as the center:

$$ℙ ( {𝕤}_{t} \vert {𝕤}_{t + 1} ) = \{ \begin{matrix}\frac{{( {τ}_{ij} )}^{α} {( {η}_{ij} )}^{β}}{{\sum }_{m ∈ {allowed}_{S}} {( {τ}_{im} )}^{α} {( {η}_{im} )}^{β}} , j ∈ {allowed}_{S} \\ 0 , otherwise\end{matrix}$$

where [symbol] (sₜ|sₜ₊₁) represents a probability of transfer from the discharge node i to another discharge node j under the action [symbol] ₜ, sₜ₊₁ represents a corresponding state when the partial discharge source node j is explored at a t+1th time point in the simulator, τᵢⱼ represents pheromone concentration corresponding to the transfer from the node i to the node j, ηᵢⱼ represents a heuristic function corresponding to the transfer from the node i to the node j, τᵢₘ represents pheromone concentration corresponding to transfer from the node i to node m contained in allowedₛ, ηᵢₘ represents a heuristic function corresponding to the transfer from the node i to the node m contained in the allowedₛ, a and β respectively represent weights of the pheromone concentration and the heuristic function, and allowedₛ represents a set of non-uniform-grid partial discharge source nodes capable of being selected at a next time point.

Further, a reward function for the transfer from the node i to the node j is

$$ℝ = \frac{1}{\vert {E}_{t}^{′} - {E}_{t} \vert} ,$$

where

$${E}_{t}^{′}$$

represents a measured discharge intensity obtained by processing a full time-domain waveform acquired by a sensor at the t^{th} time point, and Eₜ represents the simulated partial discharge intensity at the t^{th} time point.

It should be noted that, in this embodiment, a Markov model is utilized to formalize and model a state transition process in the ant colony algorithm. Such modeling can help understand and analyze a search process of the ant colony algorithm in a solution space, including key steps such as ant path selection and pheromone updating.

As a further preferred technical solution, the heuristic space parameterization module is configured to perform the following steps:

An MLP is used to extract edge feature

$${e}_{ij}^{l}$$

connecting an i^{th} node and a j^{th} node in an l^{th} layer of the GNN and map it to the heuristic metric no.

The state transition model is converted into the location exploration model that is affected by the heuristic metric and requires T-step graph traversal:

$${ℙ}_{{η}_{θ}} ( 𝕊 ) = {\prod }_{t = 1}^{T} {ℙ}_{{η}_{θ}} ( {𝕤}_{t} \vert {𝕤}_{t + 1} )$$

where [symbol] _{ηθ}( [symbol] ) represents the location exploration model, [symbol] represents the corresponding state when the partial discharge source node i is explored at the t^{th} time point in the simulator, [symbol] _{t +1} represent a corresponding state when the partial discharge source node i is explored at the t+1th time point in the simulator, T represents the exploration cycle, and t=1, 2, . . . , T.

It should be noted that, in this embodiment, the GNN-based heuristic learner is constructed. Heuristic spatial parameterization for the partial discharge source of the GIS is explored. The heuristic metric is generated by using the GNN, and the probabilistic local search is combined to achieve the better performance to ensure the efficient solving.

Further, a propagation characteristic of an l^{th} layer of the GNN is as follows:

$${h}_{i}^{l + 1} = {h}_{i}^{l} + \partial ( BN ( {U}^{l} {h}_{i}^{l} + {𝒜}_{j ∈ {𝒩}_{i}} ( σ ( {e}_{ij}^{l} ) ⊙ {V}^{l} {h}_{j}^{l} ) ) )$$

$${e}_{ij}^{l + 1} = {e}_{ij}^{l} + \partial ( BN ( {P}^{l} {e}_{ij}^{l} + {Q}^{l} {h}_{i}^{l} + {R}^{l} {h}_{j}^{l} ) )$$

In the above formula,

$${h}_{i}^{l}$$

represents a feature of a i^{th} node in the l^{th} layer,

$${h}_{j}^{l}$$

represents a feature of a j^{th} node in the l^{th} layer,

$${h}_{i}^{l + 1}$$

represents a feature of an i^{th} node in an l+1^{th} layer,

$${e}_{ij}^{l}$$

represents an edge feature connecting the i^{th} node and the j^{th} node in the l^{th} layer,

$${e}_{ij}^{l + 1}$$

represents an edge feature connecting the i^{th} node and a j^{th} node the node in the l+1^{th} layer, U^{l}, V^{l}, P^{l}, Q^{l}, and R^{l} represent learnable parameters in the l^{th} layer, σ represents an activation function, BN represents batch normalization; [symbol] represents aggregation calculation of a neighborhood of the i^{th} node, [symbol] represents the neighborhood of the i^{th} node, σ represents a Sigmoid function, O represents a Hadamard product, and l=1, 2, . . . , L.

It should be noted that when the ant colony algorithm explores a partial discharge location, a graph is constructed by traversing discharge nodes, such that nodes of the GNN correspond to the discharge nodes.

As a further preferred technical solution, the location searcher further includes a training module configured to perform the following steps:

The GNN-based heuristic learner is trained by using a gradient strategy, where objective function [symbol] (θ) adopted in a training process is as follows:

$$minimize ℒ ( θ ) = {𝔼}_{𝕊 - {ℙ}_{{η}_{θ}} ( \cdot )} [ f ( 𝕊 ) + Wf ( NLS ( 𝕊 , f , + ∞ ) ) ]$$

where f(NLS( [symbol] ,f, +∞)) represents a corresponding objective function for exploring the actual discharge location of the partial discharge source using the neural-guided perturbation-interleaved local search algorithm, W represents a parameter for balancing f( [symbol] ) and the f(NLS( [symbol] , f, +∞), [symbol] represents an expected value of exploring the actual discharge location of the partial discharge source under an impact of the heuristic metric η_{θ}, [symbol] represents a corresponding state space in the process of exploring the actual discharge location of the partial discharge source, and f(·) represents an objective function, where
a gradient of the objective function [symbol] (θ) is ∇ [symbol] (θ), which is expressed by the following formula:

$$∇ ℒ ( θ ) = {𝔼}_{𝕊 ∼ {ℙ}_{{η}_{θ}} ( \cdot )} [ ( ( f ( 𝕊 ) - \overline{f} ( 𝕊 ) ) + W ( f ( NLS ( 𝕊 , f , + ∞ ) ) - \overline{f} ( NLS ( 𝕊 , f , + ∞ ) ) ) {∇}_{θ} log {P}_{{η}_{θ}} ( 𝕊 ) ]$$

where f̅( [symbol] ) represents an average target value of directly exploring the actual discharge location of the partial discharge source, f̅(NLS( [symbol] , f, +∞) represents an average target value of exploring the actual discharge location of the partial discharge source using the neural-guided perturbation-interleaved local search algorithm, and ∇_{θ}log P_{ηθ}( [symbol] ) represents a gradient of exploring the actual discharge location of the partial discharge source under the impact of the heuristic metric η_{θ}.

When maximum quantity T_{∇} of iterations is reached or the maximum quantity T_{∇}of iterations is not reached but the objective function [symbol] (θ)<v, the training is ended, where v represents a minimum threshold corresponding to the objective function.

As a further preferred technical solution, the iterative search module is configured to perform the following steps:

The iterative search is performed on the location exploration model by using the local search algorithm, and a local optimal solution is obtained.

Specifically, a formula of the local optimal solution [symbol] *′ is as follows:

$${𝕊}^{{*}^{′}} = LS ( 𝕊 , f ( 𝕊 ) , + ∞ )$$

$$f ( \cdot ) = min {\sum }_{t = 1}^{T} {( {E}_{t}^{′} - {E}_{t} )}^{2}$$

As described above, f(·) represents the objective function, LS represents a local search operator, [symbol] represents the corresponding state space in the process of exploring the actual discharge location of the partial discharge source, LS ( ) represents an operation of performing local search on a discharge location under the local search operator,

$${E}_{t}^{′}$$

represents the measured discharge intensity obtained by processing the full time-domain waveform acquired by the sensor at the t^{th} time point, Eₜ represents the simulated partial discharge intensity at the t^{th} time point, T represents the exploration cycle, and t=1,2, . . . , T.

Neural-guided perturbation is performed on the local optimal solution obtained by the current iterative search, and an optimal exploration scheme for the actual discharge location of the partial discharge source in the current iteration is obtained through neural-guided perturbation-interleaved local search.

Specifically, the obtained optimal exploration scheme for the actual discharge location of the partial discharge source in the current iteration is expressed by the following formula:

$${𝕊}^{′} = LS ( {𝕊}^{{*}^{′}} , \frac{1}{{η}_{θ}} , {T}_{p} )$$

where [symbol] ′ represents the optimal exploration scheme that is for the actual discharge location of the partial discharge source in the current iteration and obtained by performing the neural-guided perturbation on the local optimal solution, [symbol] *′ represents the local optimal solution, Tₚ represents a quantity of perturbation movements, and ne represents the heuristic metric.

It should be noted that the local search is further performed on the optimal exploration scheme that is for the actual discharge location of the partial discharge source in the current iteration and obtained through the perturbation, local optimal solution [symbol] ″ derived from the local search for the [symbol] ′ is obtained.

$${𝕊}^{″} = LS ( {𝕊}^{′} , f ( {𝕊}^{′} ) , + ∞ )$$

Optimal exploration scheme [symbol] * for the partial discharge source of the GIS, which is obtained through the neural-guided perturbation-interleaved local search after TNLS iterations, is as follows:

$${𝕊}^{*} = arg min ( f ( {𝕊}^{*} ) , f ( {𝕊}^{″} ) )$$

In the above formula, argmin ( ) represents a set of parameters or variables that enable a function to take a minimum value.

It should be noted that when the local search algorithm is adopted to perform the iterative search on the location exploration model to obtain the local optimal solution, a problem of local optimality may arise. In this embodiment, the local optimal solution is perturbed by using the heuristic metric obtained through the training by the GNN. The heuristic metric can help the algorithm quickly locate and escape from the local optimal solution, guide the search process to approach the global optimal solution, and direct the search process to explore the solution space more effectively.

After all partial discharge source nodes are selected, pheromone concentration between the partial discharge source nodes is updated.

Specifically, a formula of updating the pheromone concentration is as follows:

$${τ}_{ij} ( k + 1 ) = {ρτ}_{ij} ( k ) + {Δτ}_{ij} ( k , k + 1 )$$

In the above formula, ρ represents an updating coefficient; τᵢⱼ(T) represents pheromone concentration within a k^{th} exploration cycle; τᵢⱼ(k+1) represents pheromone concentration within a k+1^{th} exploration cycle; and Δτᵢⱼ(k,k+1) represents a pheromone concentration change from the k^{th} exploration cycle to the k+1^{th} exploration cycle.

The optimal exploration scheme for the actual discharge location of the partial discharge source is determined when the iterative search meets an iteration convergence condition, and the actual discharge location of the partial discharge source is matched based on the optimal exploration scheme.

In this embodiment, the ant colony algorithm simulates a search process of an ant in the graph to find a possible location of the partial discharge source. The GNN can effectively propagate information of the partial discharge signal through message transfer and feature aggregation, and combine a search result of the ant colony algorithm to perform location inference and determination. With a parallel calculation capability and efficient feature learning, the GNN can quickly process large-scale graph data, and is suitable for real-time or near-real-time partial discharge positioning tasks. As a heuristic optimization method, the ant colony algorithm, combined with a feature learning capability of the GNN, can intelligently guide the search process and quickly identify a potential location of the discharge source. This method can effectively avoid falling into the local optimal solution, enhance a global search capability, and achieve fast, real-time, and high-precision positioning.

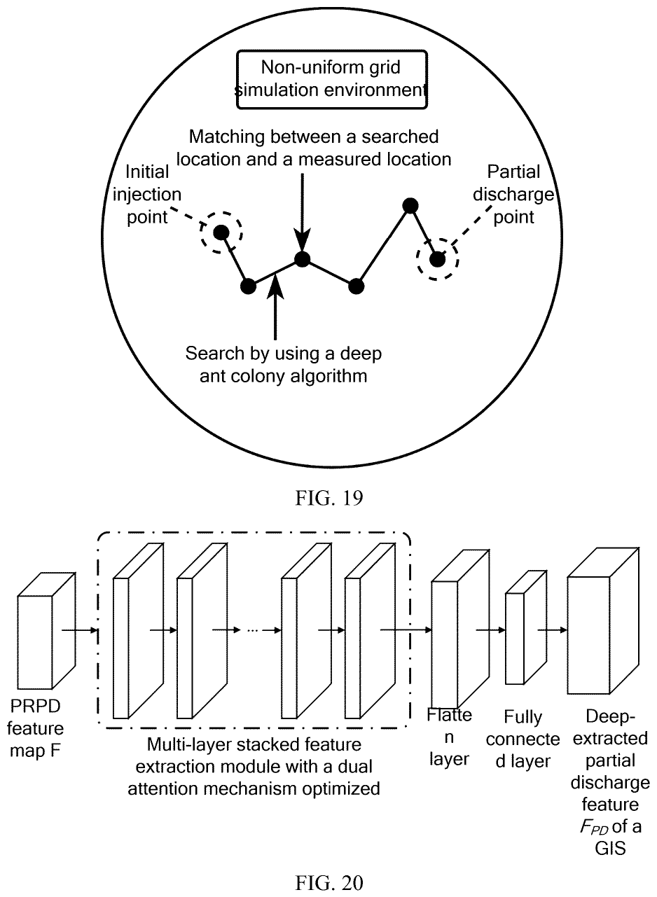

It should be noted that, as shown in FIG. 19, in this embodiment, the optimal exploration scheme is determined by taking the initial discharge location as a center of a circle and a radius of a cross-section of the GIS as a radius of a spherical region for partial discharge positioning. Moreover, the actual discharge location of the partial discharge source is matched according to a path of the optimal exploration scheme, thereby quickly determining a location of the partial discharge source.

### Embodiment 7

Based on the content disclosed in Embodiment 1, this embodiment provides detailed description of the early warning device in Embodiment 1 as follows:

A fault classification module is deployed in the early warning device. The fault classification module includes:
a deep feature extraction network configured to obtain a deep feature corresponding to a full time-domain waveform, where the deep feature extraction network includes a feature extraction network and an output network, the feature extraction network is formed by superimposing a plurality of feature extraction layers, and each of the feature extraction layers includes a channel attention module and a spatial attention module that are connected in sequence;
a reinforcement learning unit configured to construct a dataset by using the deep feature, and train, by using a deep reinforcement learning algorithm, a Markov model for feature matching of the partial discharge in the GIS, and obtain an optimal feature matching result of the partial discharge in the GIS; and
an early warning unit configured to generate the early warning information based on the optimal feature matching result of the partial discharge in the GIS and the actual discharge location of the partial discharge source, and perform early fault warning.

Specifically, as shown in FIG. 20, the deep feature extraction network includes the feature extraction network and the output network. The feature extraction network is formed by superimposing the feature extraction layers, and each of the feature extraction layers includes the channel attention module and the spatial attention module that are connected in sequence. In this embodiment, a dual-attention mechanism that fuses a spatial attention and a channel attention is adopted to extract a feature from a full time-domain waveform signal. This not only improves discriminability of a partial discharge feature of the GIS and reduces redundancy, but also consider features from spatial and various other perspectives, which is of great help for extraction of the partial discharge feature of the GIS. Meanwhile, through a deep layer formed by superimposing a plurality of layers, sample information can be fully and effectively utilized. In addition, for the extracted partial discharge feature of the GIS, the Markov model for feature matching of the partial discharge in the GIS is trained based on the deep reinforcement learning algorithm to obtain the optimal feature matching result of the partial discharge in the GIS. In the event of the partial discharge in the GIS, feature matching is achieved for the partial discharge signal of the GIS to determine a type of the partial discharge in the GIS.

### Embodiment 8

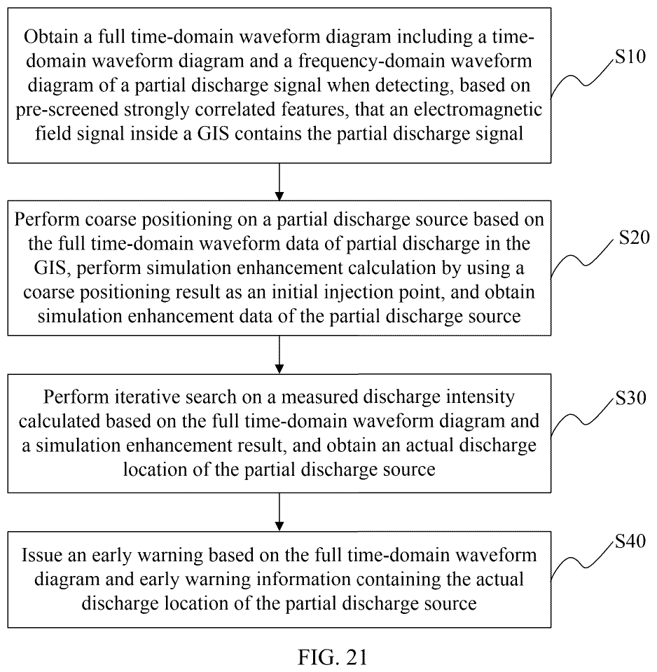

This embodiment provides a corresponding method for implementing the real-time state perception and early warning system based on field-electrical integration for a GIS in Embodiment 1. As shown in FIG. 21, the method includes the following steps:

A full time-domain waveform diagram including a time-domain waveform diagram and a frequency-domain waveform diagram of a partial discharge signal is obtained when it is detected, based on pre-screened strongly correlated features, that an electromagnetic field signal inside the GIS contains the partial discharge signal.

Coarse positioning is performed on a partial discharge source based on the full time-domain waveform diagram of partial discharge in the GIS, simulation enhancement calculation is performed by using a coarse positioning result as an initial injection point, and simulation enhancement data of the partial discharge source is obtained.

Iterative search is performed on a measured discharge intensity calculated based on the full time-domain waveform diagram and a simulation enhancement result, and an actual discharge location of the partial discharge source is obtained.

An early warning is issued based on the full time-domain waveform diagram and early warning information containing the actual discharge location of the partial discharge source.

It should be noted that the method described in the present disclosure is used to make an early warning for a GIS fault by utilizing the real-time state perception and early warning system based on field-electrical integration for a GIS in the above embodiments. For other embodiments, reference may be made to the above embodiments, and details are not described herein again.

In this specification, descriptions of reference terms such as “one embodiment”, “some embodiments”, “an example”, “a specific example”, and “some examples” indicate that specific features, structures, materials, or characteristics described in combination with the embodiment(s) or example(s) are included in at least one embodiment or example of the present disclosure. In this specification, the schematic representations of the above terms do not necessarily refer to the same embodiment or example. In addition, the specific features, structures, materials, or characteristics described may be combined in any suitable manner in any one or more embodiments or examples.

In addition, the terms “first” and “second” are merely intended for a purpose of description, and shall not be understood as an indication or implication of relative importance or an implicit indication of a quantity of indicated technical features. Therefore, a feature limited by “first” or “second” may explicitly or implicitly include at least one such feature. In the description of the present disclosure, “a plurality of” means at least two, for example, two or three, unless otherwise specifically limited.

Although the embodiments of the present disclosure have been illustrated and described above, it can be appreciated that the above embodiments are illustrative and should not be construed as limiting the present disclosure. Changes, modifications, substitutions, and variations can be made to the above embodiments by a person of ordinary skill in the art within the scope of the present disclosure.

What is claimed is:

1. A real-time state perception and early warning system based on field-electrical integration for a gas insulated switchgear (GIS), comprising an embedded device for synchronous signal acquisition and measurement and an industrial personal computer (IPC), wherein a simulator, a location searcher, and an early warning device are deployed in the IPC;
the embedded device for synchronous signal acquisition and measurement is configured to obtain a full time-domain waveform diagram comprising a time-domain waveform diagram and a frequency-domain waveform diagram of a partial discharge signal when detecting, based on pre-screened strongly correlated features, that an electromagnetic field signal inside the GIS contains the partial discharge signal;
the simulator is configured to perform coarse positioning on a partial discharge source based on the full time-domain waveform diagram of partial discharge in the GIS, perform simulation enhancement calculation by using a coarse positioning result as an initial injection point, and obtain simulation enhancement data of the partial discharge source;
the location searcher is configured to perform iterative search on a measured discharge intensity calculated based on the full time-domain waveform diagram and a simulation enhancement result, and obtain an actual discharge location of the partial discharge source; and
the early warning device is configured to issue an early warning based on the full time-domain waveform diagram and early warning information containing the actual discharge location of the partial discharge source.

2. The real-time state perception and early warning system based on the field-electrical integration for the GIS according to claim 1, wherein the embedded device for synchronous signal acquisition and measurement comprises:
a signal acquisition location determining module configured to determine an installation location of each sensor in a signal acquisition module;
the signal acquisition module configured to acquire the electromagnetic field signal inside the GIS;
a signal processing front end configured to perform signal conditioning on the electromagnetic field signal transmitted by the signal acquisition module, and transmit a conditioned signal to an analog-to-digital converter (ADC);
the ADC configured to convert the conditioned signal from an analog signal to a digital signal and transmit the digital signal to a signal measurement module; and
the signal measurement module configured to monitor the digital signal based on the pre-screened strongly correlated features, and obtain the full time-domain waveform diagram comprising the time-domain waveform diagram and the frequency-domain waveform diagram of the partial discharge signal when determining that the partial discharge signal is monitored, wherein the strongly correlated features comprise time-domain strongly correlated features and frequency-domain strongly correlated features.

3. The real-time state perception and early warning system based on the field-electrical integration for the GIS according to claim 2, wherein the embedded device for synchronous signal acquisition and measurement further comprises: a feature screening module configured to take time-domain and frequency-domain features for detecting the partial discharge signal as nodes of a graph neural network (GNN) to perform correlation strength screening, and obtain the time-domain strongly correlated features and the frequency-domain strongly correlated features, wherein a connection line between the nodes represents a relationship between features represented by the nodes.

4. The real-time state perception and early warning system based on the field-electrical integration for the GIS according to claim 3, wherein the feature screening module comprises:
a feature map construction unit configured to set xᵥ, x_{co[v]}, h_{ne[v]}, x_{ne[v]} to respectively represent a feature vector of a node v, a feature vector of an edge, a state vector of the node v and a neighboring node of the node v, and a feature vector of the neighboring node of the node v in a complete feature map G=(V, E) of the GNN, wherein V represents a node set, and E represents an edge set;
an aggregation updating unit configured to perform aggregation updating on input node and edge information based on a local transition function for updating a node state, and output a node label, with a formula expressed as follows:
$${h}_{v} = f ( {x}_{v} , {x}_{co [ v ]} , {h}_{ne [ v ]} , {x}_{ne [ v ]} )$$
$${o}_{v} = g ( {h}_{v} , {x}_{v} )$$
wherein f(·) represents the local transition function for updating the node state, g(.) represents a local output function, hᵥ represents a state vector learned through iterative learning of the GNN, and oᵥ represents the node label; and
an iteration unit configured to calculate a correlation between a node and an adjacent node during continuous iteration of the GNN, and obtain the time-domain strongly correlated features and the frequency-domain strongly correlated features.

5. The real-time state perception and early warning system based on the field-electrical integration for the GIS according to claim 4, wherein the iteration unit is specifically configured to:
respectively set H,O, X, and X_{N} to a vector constructed by superimposing state vectors of all the nodes, a vector constructed by superimposing all output labels, a vector constructed by superimposing feature vectors of all the nodes and all edges, and a vector constructed by superimposing feature vectors of all the nodes, and write formulas in a more compact form as follows:
$$O = G ( H , {X}_{N} )$$
$${H}^{t + 1} = F ( {H}^{t} , X )$$
wherein H^{t} represents a t^{th} iteration of the H, H^{t+1}=F(H^{t}, X) represents an operation of obtaining state vectors of all the nodes in a t+1^{th} iteration based on a feature vector and a state vector of the t^{th} iteration through a global transition function, and F(.) and G(.) respectively represent the global transition function and a global output function, and are respectively obtained by stacking local transition functions f(·) and local output functions g(.) of all the nodes; and
in an iteration process, determine nodes with similar states, nodes with complementary states, and overall impacts of all the nodes on the GNN, and take one node selected from the nodes with similar states, one node merged from the nodes with complementary states, and a node with a greatest overall impact on the GNN as the strongly correlated features.

6. The real-time state perception and early warning system based on the field-electrical integration for the GIS according to claim 2, wherein the signal measurement module comprises:
a caching unit configured to cache the digital signal;
a first monitoring unit configured to extract the time-domain strongly correlated features from the digital signal, determine, based on the time-domain strongly correlated features, that the partial discharge signal is monitored, and output a first time-domain waveform diagram during discharge;
a second monitoring unit configured to extract the frequency-domain strongly correlated features from the digital signal, determine, based on the frequency-domain strongly correlated features, that the partial discharge signal is monitored, and output a frequency-domain waveform diagram during the discharge; and
a waveform synthesis unit configured to obtain the full time-domain waveform diagram of the partial discharge signal based on the first time-domain waveform diagram and the frequency-domain waveform diagram.

7. The real-time state perception and early warning system based on the field-electrical integration for the GIS according to claim 6, wherein the second monitoring unit comprises:
a Fourier transform subunit configured to perform at least two fast Fourier transform operations on the electromagnetic field signal, and obtain frequency-domain data of at least two frequency bands; and
a normalization subunit configured to extract the frequency-domain strongly correlated features from frequency-domain data of each of the at least two frequency bands, perform normalization processing on a frequency-domain waveform corresponding to each of the at least two frequency bands when determining that the frequency-domain data of each of the at least two frequency bands exceeds a second discharge threshold after analyzing and matching the frequency-domain strongly correlated features, and obtain the frequency-domain waveform diagram during the discharge.

8. The real-time state perception and early warning system based on the field-electrical integration for the GIS according to claim 6, wherein the waveform synthesis unit comprises:
a waveform conversion subunit configured to convert the frequency-domain waveform diagram into a second time-domain waveform diagram during the discharge; and
a waveform synthesis subunit configured to synthesize the first time-domain waveform diagram and the second time-domain waveform diagram, and obtain the full time-domain waveform diagram of the partial discharge signal.

9. The real-time state perception and early warning system based on the field-electrical integration for the GIS according to claim 1, wherein the simulator comprises:
a simulation module configured to take the coarse positioning result that is of the partial discharge source and obtained based on the full time-domain waveform diagram as an initial injection point of a three-dimensional simulation model of the GIS to simulate a partial discharge phenomenon of the GIS, and perform simulation calculation to obtain a coarse-grid simulation result; and
an enhancement module configured to enhance the coarse-grid simulation result by using an enhancement model, and obtain the simulation enhancement data.

10. The real-time state perception and early warning system based on the field-electrical integration for the GIS according to claim 9, wherein the simulation module comprises:
a spatial discretization unit configured to discretize the three-dimensional simulation model of the GIS into spatial grids, and determine a corresponding relationship between a number and spatial coordinate data of each grid node; and
a differential simulation unit configured to inject the coarse positioning result into a corresponding spatial grid as the initial injection point to simulate the partial discharge phenomenon of the GIS, convert a Maxwell's equation describing an electromagnetic field of the GIS into a fourth-order matrix, solve the fourth-order matrix by using a four-step hybrid implicit-explicit finite-difference time domain (HIE-FDTD) algorithm, and calculate field strength data of each grid node.

11. The real-time state perception and early warning system based on the field-electrical integration for the GIS according to claim 10, wherein the differential simulation unit comprises:
a matrix reconstruction subunit configured to convert the Maxwell's equation describing the electromagnetic field of the GIS into a form of a sixth-order matrix:
$$\frac{\partial \vec{u}}{\partial t} = [ M ] \vec{u}$$
wherein \vec{u} represents a vector composed of components of an electric field and a magnetic field in a rectangular coordinate system, and [M] represents the sixth-order matrix;
a matrix conversion subunit configured to convert the form of the sixth-order matrix into the form of the fourth-order matrix:
$$\frac{\partial \vec{u}}{\partial t} = \frac{[ {A}_{H} ]}{2} \vec{u} + \frac{[ {B}_{H} ]}{2} \vec{u} + \frac{[ {A}_{H} ]}{2} \vec{u} + \frac{[ {B}_{H} ]}{2} \vec{u}$$
wherein [A_{H}] and [B_{H}] represent sixth-order matrices; and
a solving subunit configured to solve the fourth-order matrix by using the four-step HIE-FDTD algorithm, and calculate the field strength data of each grid node.

12. The real-time state perception and early warning system based on the field-electrical integration for the GIS according to claim 11, wherein the solving subunit is configured to perform following steps:
decomposing the four-step HIE-FDTD algorithm into four sub-steps in a time domain, namely n→n+¼, n+¼→n+2/4, n+2/4→n+¾, and n+¾→n+1, and for each of the sub-steps, using a semi-implicit difference scheme to calculate a tridiagonal implicit form of the field strength data of the grid node; and
solving the tridiagonal implicit form by using a chasing method, and obtaining the field strength data of the grid node.

13. The real-time state perception and early warning system based on the field-electrical integration for the GIS according to claim 9, wherein the enhancement model adopts a differential deep learning network model, and the coarse-grid simulation result comprises coarse-grid structure data and coarse-grid field strength data, wherein the differential deep learning network model comprises an enhancement network and a structural similarity network that are connected in sequence, and the enhancement network comprises a self-adjustment module and a differential convolution module;
the coarse-grid structure data and the coarse-grid field strength data are respectively calculated by using the self-adjustment module and the differential convolution module, and a fine-grid enhanced grid structure feature and a fine-grid enhanced field strength feature are obtained;
the fine-grid enhanced grid structure feature and the fine-grid enhanced field strength feature are matched by using the structural similarity network, and a similarity feature is calculated; and
the simulation enhancement data is calculated based on the similarity feature.

14. The real-time state perception and early warning system based on the field-electrical integration for the GIS according to claim 13, wherein the self-adjustment module comprises a first convolutional layer and a second convolutional layer that are connected in sequence, and an output feature of the first convolutional layer and an output feature of the second convolutional layer are output to an activation function layer after a first addition operation; and
the coarse-grid structure data is used as an input of the first convolutional layer, supplementary grid size information of the coarse-grid structure data is used as an input of the second convolutional layer, a bias vector of the coarse-grid structure data is used as an input of the first addition operation, and the coarse-grid structure data and the supplementary grid size information of the coarse-grid structure data are output to the first addition operation through a residual connection.

15. The real-time state perception and early warning system based on the field-electrical integration for the GIS according to claim 13, wherein the differential convolution module comprises a differential convolutional layer, a size integration layer, a self-attention mechanism layer, and a third convolutional layer that are connected in sequence, and an activation function is connected after the third convolutional layer;
the coarse-grid field strength data is used as an input of the differential convolutional layer, and the differential convolutional layer is configured to calculate field strength features of different sizes of the coarse-grid field strength data by using a differential algorithm; and
the size integration layer is configured to sum the field strength features of different sizes calculated by the differential convolutional layer, and obtain a reorganized field strength feature.

16. The real-time state perception and early warning system based on the field-electrical integration for the GIS according to claim 15, wherein a convolution kernel of the differential convolutional layer adopts any one of a five-point differential convolution kernel, a weighted differential convolution kernel, a multi-scale differential convolution kernel, a directional differential convolution kernel, a nine-point differential convolution kernel, and a hybrid differential convolution kernel.

17. The real-time state perception and early warning system based on the field-electrical integration for the GIS according to claim 13, wherein the structural similarity network comprises a first branch network, a second branch network, a second addition operation, and a first multi-layer perceptron (MLP), outputs of the first branch network and the second branch network are both connected to the second addition operation, an output of the second addition operation is connected to the first MLP, and an activation function is connected after the MLP.

18. The real-time state perception and early warning system based on the field-electrical integration for the GIS according to claim 17, wherein the first branch network comprises a convolutional neural network (CNN) layer and a batch normalization operation that are connected in sequence, and an activation function is connected after the batch normalization operation; and
the second branch network comprises a second MLP, and an activation function is connected after the second MLP.

19. The real-time state perception and early warning system based on the field-electrical integration for the GIS according to claim 18, wherein that the fine-grid enhanced grid structure feature and the fine-grid enhanced field strength feature are matched by using the structural similarity network, and the similarity feature is calculated comprises:
extracting structural feature information of the fine-grid enhanced grid structure feature by using the first branch network, with a formula expressed as follows:
$${f}_{k , S}^{CNN} = Re LU ( BatchNorm ( CNN ( {f}_{k , S}^{new} ) ) )$$
wherein
$${f}_{k , S}^{CNN}$$
represents feature information of a k^{th} fine-grid enhanced grid structure feature,
$${f}_{k , S}^{new}$$
represents the fine-grid enhanced grid structure feature, CNN( ) represents a stacked convolution operation, BatchNorm( ) represents the batch normalization operation, and ReLU represents the activation function;
extracting field strength feature information of the fine-grid enhanced field strength feature by using the second branch network, with a formula expressed as follows:
$${f}_{k , E}^{MLP} = ReLU ( MLP ( {f}_{k , E}^{new} ) )$$
wherein
$${f}_{k , E}^{MLP}$$
represents feature information of a k^{th} fine-grid enhanced field strength feature,
$${f}_{k , E}^{new}$$
represents the fine-grid enhanced field strength feature, and MLP( ) represents an operation performed by the second MLP;
calculating a combined field strength and structure feature based on modulation weights corresponding to the feature information of the fine-grid enhanced grid structure feature and the feature information of the fine-grid enhanced field strength feature, with a formula expressed as follows:
$${f}_{k , combined} = α \cdot {f}_{k , S}^{CNN} + β \cdot {f}_{k , E}^{MLP}$$
wherein f_{k,combined} represents the combined field strength and structure feature, and α and β respectively represent the modulation weights corresponding to the feature information of the fine-grid enhanced grid structure feature and the feature information of the fine-grid enhanced field strength feature; and
calculating the similarity feature based on the combined field strength and structure feature, with a formula expressed as follows:
$${f}_{k , final} = ReLU ( {MLP}_{final} ( {f}_{k , combined} ) )$$
wherein f_{k,final} represents the similarity feature, and MLP_{final}( ) represents an operation performed by the first MLP.

20. The real-time state perception and early warning system based on the field-electrical integration for the GIS according to claim 13, wherein that the simulation enhancement data is calculated based on the similarity feature comprises:
calculating regularized coarse-grid structure data, regularized coarse-grid field strength data, a regularized fine-grid enhanced grid structure feature, and a regularized fine-grid enhanced field strength feature respectively based on the coarse-grid structure data, the coarse-grid field strength data, the fine-grid enhanced grid structure feature, and the fine-grid enhanced field strength feature;
calculating grid structure consistency based on the regularized coarse-grid structure data and the regularized fine-grid enhanced grid structure feature;
calculating grid field strength consistency based on the regularized coarse-grid field strength data and the regularized fine-grid enhanced field strength feature;
calculating a compensation for a grid field strength loss based on the grid structure consistency and the grid field strength consistency;
calculating fine-grid enhanced structure data based on the fine-grid enhanced grid structure feature, the compensation for the grid field strength loss, and the similarity feature; and
calculating the simulation enhancement data based on the fine-grid enhanced field strength feature, the compensation for the grid field strength loss, and the similarity feature.

21. The real-time state perception and early warning system based on the field-electrical integration for the GIS according to claim 1, wherein the simulation enhancement data comprises an enhanced discharge location and an enhanced discharge intensity, and the location searcher comprises:
a state transition model construction module configured to reconstruct an ant colony algorithm by using a Markov decision model based on an enhanced discharge location and an enhanced discharge intensity at each time point to construct a state transition model corresponding to a process of exploring the actual discharge location of the partial discharge source by taking the coarse positioning result of the partial discharge source as a center;
a heuristic space parameterization module configured to generate a heuristic metric by using a GNN-based heuristic learner, and convert the state transition model into a location exploration model that is affected by the heuristic metric and requires graph traversal; and
an iterative search module configured to perform iterative search on the location exploration model by using a neural-guided perturbation-interleaved local search algorithm, and obtain the actual discharge location of the partial discharge source.

22. The real-time state perception and early warning system based on the field-electrical integration for the GIS according to claim 21, wherein the state transition model construction module is configured to:
construct, based on a simulated discharge location and a simulated discharge intensity at each time point, a corresponding state space [symbol] in the process of exploring the actual discharge location of the partial discharge source in the simulator:
$$𝕊 = [ {𝕤}_{1} , … , {𝕤}_{t} , … , {𝕤}_{T} ]$$
$${𝕤}_{t} = [ {p}_{t} , {E}_{t} ]$$
wherein [symbol] ₜ represents a corresponding state when a partial discharge source node i is explored at a t^{th} time point in the simulator, pₜ represents a simulated discharge location at the t^{th} time point, Eₜ represents a simulated discharge intensity at the t^{th} time point, [symbol] ₁=[P, E] represents an operation of taking an initial discharge intensity E and an initial discharge location P that are of the partial discharge source and obtained based on the full time-domain waveform diagram of the partial discharge in the GIS as an initial state, T represents an exploration cycle, and t=1, 2, . . . , T;
construct a corresponding action space [symbol] in the process of exploring the actual discharge location of the partial discharge source in the simulator:
$$𝔸 = [ {𝕒}_{1} , … , {𝕒}_{t} , … , {𝕒}_{T} ]$$
wherein [symbol] ₜ represents an action at the t^{th} time point, and the action [symbol] ₜ is selected based on a ε—greedy strategy; and
reconstruct the ant colony algorithm to construct the state transition model corresponding to the process of exploring the actual discharge location of the partial discharge source by taking the initial discharge location of the partial discharge source as the center:
$$ℙ ( {𝕤}_{t} \vert {𝕤}_{t + 1} ) = \{ \begin{matrix}\frac{{( {τ}_{ij} )}^{α} {( {η}_{ij} )}^{b}}{{\sum }_{mϵ {allowed}_{S}} {( {τ}_{im} )}^{α} {( {η}_{im} )}^{b}} , j ϵ {allowed}_{S} \\ 0 , otherwise\end{matrix}$$
wherein [symbol] (sₜ|sₜ₊₁) represents a probability of transfer from the discharge node i to another discharge node j under the action [symbol] ₜ, sₜ₊₁ represents a corresponding state when the partial discharge source node j is explored at a t+1th time point in the simulator, τᵢⱼ represents pheromone concentration corresponding to the transfer from the node i to the node j, ηᵢⱼ represents a heuristic function corresponding to the transfer from the node i to the node j, τᵢⱼ represents pheromone concentration corresponding to transfer from the node i to a node m contained in allowedₛ, ηᵢₘ represents a heuristic function corresponding to the transfer from the node i to the node m contained in the allowedₛ, α and β respectively represent weights of the pheromone concentration and the heuristic function, and allowedₛ represents a set of non-uniform-grid partial discharge source nodes capable of being selected at a next time point.

23. The real-time state perception and early warning system based on the field-electrical integration for the GIS according to claim 22, wherein a reward function for the transfer from the node i to the node j is
$$ℝ = \frac{1}{\vert {{E}_{t}}^{′} - {E}_{t} \vert} ,$$
wherein
$${{E}_{t}}^{′}$$
represents a measured discharge intensity obtained by processing a full time-domain waveform acquired by a sensor at the t^{th} time point, and Eₜ represents the simulated partial discharge intensity at the t^{th} time point.

24. The real-time state perception and early warning system based on the field-electrical integration for the GIS according to claim 21, wherein the heuristic space parameterization module is configured to map an edge feature
$${e}_{i j}^{l}$$
connecting an i^{th} node and a j^{th} node in an l^{th} layer of a GNN to the heuristic metric η_{θ}; and
convert the state transition model into the location exploration model that is affected by the heuristic metric and requires T-step graph traversal:
$${ℙ}_{{η}_{θ}} ( 𝕊 ) = {\prod }_{t = 1}^{T} {ℙ}_{{η}_{θ}} ( {𝕤}_{t} \vert {𝕤}_{t + 1} )$$
wherein [symbol] _{ηθ}( [symbol] ) represents the location exploration model, sₜ represents a corresponding state when a partial discharge source node i is explored at a t^{th} time point in the simulator, [symbol] ₜ₊₁ represent a corresponding state when the partial discharge source node i is explored at a t+1th time point in the simulator, T represents an exploration cycle, and t=1, 2, . . . , T.

25. The real-time state perception and early warning system based on the field-electrical integration for the GIS according to claim 21, wherein the location searcher further comprises a training module configured to:
train the GNN-based heuristic learner by using a gradient strategy, wherein an objective function [symbol] (θ) adopted in a training process is as follows:
$$minimize ℒ ( θ ) = {𝔼}_{𝕊 ∼ {ℙ}_{{η}_{θ}} ( \cdot )} [ f ( 𝕊 ) + Wf ( NLS ( 𝕊 , f , + ∞ ) ) ]$$
wherein f(NLS( [symbol] , f, +∞)) represents a corresponding objective function for exploring the actual discharge location of the partial discharge source using the neural-guided perturbation-interleaved local search algorithm, W represents a parameter for balancing f(S) and the f(NLS(S, f, +∞)), [symbol] represents an expected value of exploring the actual discharge location of the partial discharge source under an impact of the heuristic metric η_{θ}, S represents a corresponding state space in the process of exploring the actual discharge location of the partial discharge source, and f(·) represents an objective function, wherein
a gradient of the objective function [symbol] (θ) is ∇ [symbol] (θ), with a formula expressed as follows:
$$∇ ℒ ( θ ) = {𝔼}_{𝕊 ∼ {ℙ}_{{η}_{θ}} ( \cdot )} [ ( ( f ( 𝕊 ) - \overline{f} ( 𝕊 ) ) + W ( f ( NLS ( 𝕊 , f , + ∞ ) ) - \overline{f} ( NLS ( 𝕊 , f , + ∞ ) ) ) {∇}_{θ} log {P}_{{η}_{θ}} ( 𝕊 ) ]$$
wherein f̅(S) represents an average target value of directly exploring the actual discharge location of the partial discharge source, f̅(NLS(S, f, +∞) represents an average target value of exploring the actual discharge location of the partial discharge source using the neural-guided perturbation-interleaved local search algorithm, and ∇_{θ}log P_{ηθ}(S) represents a gradient of exploring the actual discharge location of the partial discharge source under the impact of the heuristic metric η_{θ}; and
when a maximum quantity T_{∇} of iterations is reached or the maximum quantity T_{∇} of iterations is not reached but the objective function [symbol] (θ)<v, end the training, wherein represents a minimum threshold corresponding to the objective function.

26. The real-time state perception and early warning system based on the field-electrical integration for the GIS according to claim 21, wherein the iterative search module comprises:
a local search unit configured to perform the iterative search on the location exploration model by using the local search algorithm, and obtain a local optimal solution;
a perturbation unit configured to perform neural-guided perturbation on the local optimal solution obtained by the current iterative search, and obtain an optimal exploration scheme for the actual discharge location of the partial discharge source in the current iteration through neural-guided perturbation-interleaved local search;
a pheromone concentration updating unit configured to: after all partial discharge source nodes are selected, update pheromone concentration between the partial discharge source nodes; and
an exploration unit configured to determine the optimal exploration scheme for the actual discharge location of the partial discharge source when the iterative search meets an iteration convergence condition, and match the actual discharge location of the partial discharge source based on the optimal exploration scheme.

27. The real-time state perception and early warning system based on the field-electrical integration for the GIS according to claim 26, wherein a process in which the perturbation unit explores the optimal exploration scheme for the actual discharge location of the partial discharge source in the current iteration is expressed by a following formula:
$${𝕊}^{′} = LS ( {𝕊}^{* ′} , \frac{1}{{η}_{θ}} , {T}_{p} )$$
wherein [symbol] ′ represents the optimal exploration scheme that is for the actual discharge location of the partial discharge source in the current iteration and obtained by performing the neural-guided perturbation on the local optimal solution, [symbol] *′ represents the local optimal solution, Tₚ represents a quantity of perturbation movements, and η_{θ} represents the heuristic metric.

28. The real-time state perception and early warning system based on the field-electrical integration for the GIS according to claim 1, wherein a fault classification module is deployed in the early warning device, and the fault classification module comprises:
a deep feature extraction network configured to obtain a deep feature corresponding to an ultra-high frequency (UHF) signal, wherein the deep feature extraction network comprises a feature extraction network and an output network, the feature extraction network is formed by superimposing a plurality of feature extraction layers, and each of the feature extraction layers comprises a channel attention module and a spatial attention module that are connected in sequence;
a reinforcement learning unit configured to construct a dataset by using the deep feature, and train, by using a deep reinforcement learning algorithm, a Markov model for feature matching of the partial discharge in the GIS, and obtain an optimal feature matching result of the partial discharge in the GIS; and
an early warning unit configured to generate the early warning information based on the optimal feature matching result of the partial discharge in the GIS and the actual discharge location of the partial discharge source, and perform early fault warning.

29. A real-time state perception and early warning method based on field-electrical integration for a GIS, wherein the real-time state perception and early warning method is applied to the real-time state perception and early warning system based on the field-electrical integration for the GIS according to claim 1 to issue an early alarm for a GIS fault, and comprises:
obtaining a full time-domain waveform diagram comprising a time-domain waveform diagram and a frequency-domain waveform diagram of a partial discharge signal when detecting, based on pre-screened strongly correlated features, that an electromagnetic field signal inside the GIS contains the partial discharge signal;
performing coarse positioning on a partial discharge source based on the full time-domain waveform diagram of partial discharge in the GIS, performing simulation enhancement calculation by using a coarse positioning result as an initial injection point, and obtaining simulation enhancement data of the partial discharge source;
performing iterative search on a measured discharge intensity calculated based on the full time-domain waveform diagram and a simulation enhancement result, and obtaining an actual discharge location of the partial discharge source; and
issuing an early warning based on the full time-domain waveform diagram and early warning information containing the actual discharge location of the partial discharge source.
